(19) United States
(12) Patent Application Publication
(10) Pub. No.: US 2024/0174799 A1
(43) Pub. Date: May 30, 2024

(54) METHOD FOR PRODUCING WATER-BASED POLYESTER RESIN, WATER-BASED POLYESTER RESIN, AND WATER-BASED COATING COMPOSITION

(71) Applicant: GOO CHEMICAL CO., LTD., Kyoto (JP)

(72) Inventors: Teru SAKAKIBARA, Kyoto (JP); Shinya KOMABIKI, Kyoto (JP)

(21) Appl. No.: 18/552,898

(22) PCT Filed: Mar. 9, 2022
(86) PCT No.: PCT/JP2022/010184

§ 371 Date: Sep. 28, 2023

(30) Foreign Application Priority Data
Mar. 31, 2021 (JP) 2021-061295
Oct. 22, 2021 (JP) 2021-173116

(51) Int. Cl. C08G 63/688; C08G 63/78; C09D 167/02

(52) U.S. Cl. CPC C08G 63/6886; C08G 63/78; C09D 167/02

(57) ABSTRACT

A method for producing a water-based polyester resin includes a first step and a second step. The first step includes causing an ester formation reaction and a depolymerization reaction using a recycled polyester, a polycarboxylic acid component including a polycarboxylic acid residue and excluding terephthalic acid, and a polyalcohol component. The second step includes causing a polycondensation reaction by reducing pressure. The first step includes using: the recycled polyester to such an amount that makes proportion of a terephthalic acid residue equal to or greater than 20% by mass and equal to or less than 72% by mass; and a metal-sulfonate-group-containing polycarboxylic acid compound to such an amount that makes proportion of the metal-sulfonate-group-containing polycarboxylic acid residue equal to or greater than 5% by mass and equal to or less than 32% by mass. The resin thus produced has an acid value equal to or less than 10 mgKOH/g.

### TECHNICAL FIELD

The present disclosure generally relates to a method for producing a water-based polyester resin, a water-based polyester resin, and a water-based coating composition. More particularly, the present disclosure relates to a method for producing a water-based polyester resin using a recycled polyester, a water-based polyester resin produced by using a recycled polyester, and a water-based coating composition containing such a water-based polyester resin.

### BACKGROUND ART

It has been proposed that a water-based polyester resin, which is dispersible in either water or water containing a hydrophilic solvent, should be produced, from the viewpoint of environmental friendliness, by using a recycled polyester as a material and copolymerizing a hydrophilic component thereof (see Patent Documents 1 to 4). However, the water-based polyester resin produced by any of the methods of these documents tends to exhibit relatively low water dispersibility. In addition, it is also difficult to keep the water-based polyester resin dispersed in the liquid for a long time. In other words, the resin dispersion liquid tends to have relatively low stability. These tendencies are particularly noticeable when a polycarboxylic acid having a metal sulfonate group as the hydrophilic component thereof is used.

These tendencies are displayed probably for the following reasons. Firstly, the main component of the recycled polyester is polyethylene terephthalate (PET), which is a resin with a high degree of crystallinity. Secondly, the molecular weight of recycled polyesters currently available is not uniform but varies depending on the type of the waste polyester material to be recycled or the method of conducting post-treatment on the waste polyester material. That is to say, these tendencies would have something to do with the rigidity of the molecular structure of the water-based polyester resin and the varying degree of depolymerization reaction produced in the recycled polyester during its production process.

On the other hand, examples of methods for improving the water dispersibility of the water-based polyester resin and the stability of a resin dispersion liquid thereof include lowering the compound ratio of the recycled polyester and adding a surfactant as a dispersing aid to the resin dispersion. However, from the viewpoint of environmental friendliness, it is preferable that the compound ratio of the recycled polyester be as high as possible. In addition, if a surfactant is used, the surfactant may bleed out onto a resin film formed out of the resin dispersion liquid, thus sometimes causing a decline in the physical properties of the resin film or contaminating other materials when the surfactant comes into contact with the materials. Moreover, the use of a dissimilar material such as surfactant causes a decrease in the recyclability of the material, leading to an increase in environmental load.

As can be seen, there has been an increasing demand for producing, based on a recycled polyester, a water-based polyester resin which exhibits not only excellent water dispersibility even in the absence of any surfactant, for example, but also good stability when used as a resin dispersion liquid. In addition, the water-based polyester which is produced using the recycled polyester is sometimes required to have properties comparable to a water-based polyester produced using non-recycled terephthalic acid or a terephthalic acid derivative not derived from the recycled polyester. In particular, the water-based polyester resin is required to have good adhesion to resins and metals and excellent transparency (e.g., its haze should be sufficiently low). In addition, the dispersion liquid of the water-based polyester resin is required to not only exhibit good water dispersibility for a long term but also improve its stability such as aging stability in solution haze.

### CITATION LIST

### Patent Literature

Patent Document 1: WO 2001/016208 A1

Patent Document 2: JP H05-271612 A

Patent Document 3: WO 2003/051956 A1

Patent Document 4: JP 2001-505608 A

### SUMMARY OF INVENTION

The problem to be overcome by the present disclosure is to provide a water-based polyester resin having the following advantageous features and a water-based coating composition containing such a water-based polyester resin. Specifically, the water-based polyester resin to be provided by the present disclosure would exhibit not only excellent water dispersibility even in the absence of any surfactant, for example, but also good stability when used as a resin dispersion liquid while reducing the environmental load. In addition, the water-based polyester resin includes a residue of terephthalic acid derived from a recycled polyester and would still have as good resin properties (such as adhesion and transparency) as in a situation where terephthalic acid or a terephthalic acid derivative not derived from a recycled polyester is used. Furthermore, the resin dispersion liquid of the water-based polyester resin would not only exhibit good water dispersibility for a long term but also improve its stability such as aging stability in solution haze.

A method for producing a water-based polyester resin according to an aspect of the present disclosure is a method for producing a water-based polyester resin using a recycled polyester. The method includes a first step and a second step. The first step includes causing an ester formation reaction and a depolymerization reaction using the recycled polyester, a polycarboxylic acid component including a polycarboxylic acid residue and excluding terephthalic acid, and a polyalcohol component. The second step includes causing a polycondensation reaction by reducing pressure. The polycarboxylic acid component includes; at least one metal-sulfonate-group-containing polycarboxylic acid compound selected from the group consisting of polycarboxylic acids, each having a metal sulfonate group and including a metal-sulfonate-group-containing polycarboxylic acid residue, and esters and anhydrides thereof; and at least one additional polycarboxylic acid compound selected from the group consisting of polycarboxylic acids other than the terephthalic acid and the metal-sulfonate-group-containing polycarboxylic acid compound and esters and anhydrides thereof. The first step includes using: the recycled polyester to such an amount that makes proportion of the terephthalic acid residue with respect to a total of the terephthalic acid residue included in the recycled polyester and the polycarboxylic acid residue included in the polycarboxylic acid component equal to or greater than 20% by mass and equal to or less than 72% by mass; and the metal-sulfonate-group-containing polycarboxylic acid compound to such an amount that makes proportion of the metal-sulfonate-group-containing polycarboxylic acid residue with respect to a total of the terephthalic acid residue included in the recycled polyester and the polycarboxylic acid residue included in the polycarboxylic acid component equal to or greater than 5% by mass and equal to or less than 32% by mass. The water-based polyester resin thus produced has an acid value equal to or less than 10 mgKOH/g.

A water-based polyester resin according to another aspect of the present disclosure is produced by the method for producing a water-based polyester resin described above.

A water-based polyester resin according to still another aspect of the present disclosure contains: a terephthalic acid residue derived from a recycled polyester; and a polycarboxylic acid residue other than the terephthalic acid residue. The polycarboxylic acid residue includes: a metal-sulfonate-group-containing polycarboxylic acid residue; and an additional polycarboxylic acid residue other than the terephthalic acid residue and the metal-sulfonate-group-containing polycarboxylic acid residue. Proportion of the terephthalic acid residue with respect to the entire polycarboxylic acid residue included in the water-based polyester resin is equal to or greater than 20% by mass and equal to or less than 72% by mass. Proportion of the metal-sulfonate-group-containing polycarboxylic acid residue with respect to the entire polycarboxylic acid residue included in the water-based polyester resin is equal to or greater than 5% by mass and equal to or less than 32% by mass. The water-based polyester resin has an acid value equal to or less than 10 mgKOH/g.

A water-based coating composition according to yet another aspect of the present disclosure contains a water-based polyester resin. The water-based polyester resin includes either the water-based polyester resin produced by the method described above or the water-based polyester resin described above.

### DESCRIPTION OF EMBODIMENTS

<Method for Producing Water-Based Polyester Resin>

A method for producing a water-based polyester resin according to an exemplary embodiment (hereinafter referred to as a “production method (X)”) is a method for producing a water-based polyester resin according to the exemplary embodiment using a recycled polyester. The production method (X) includes a first step and a second step.

The production method (X) according to this embodiment enables producing a water-based polyester resin having the following advantageous features. Specifically, the water-based polyester resin exhibits not only excellent water dispersibility even in the absence of any surfactant, for example, but also good stability when used as a resin dispersion liquid, while reducing the environmental load. In addition, the water-based polyester resin includes a terephthalic acid residue derived from a recycled polyester and still has as good resin properties (such as adhesion and transparency) as in a situation where terephthalic acid or a terephthalic acid derivative not derived from a recycled polyester is used. Furthermore, the resin dispersion liquid of the water-based polyester resin not only exhibits good water dispersibility for a long term but also has improved stability such as aging stability in solution haze. The present inventors discovered that the problem described above could be overcome by: using, when producing a water-based polyester resin using not only a recycled polyester but also a metal-sulfonate-group-containing polycarboxylic acid compound as a hydrophilic component, an additional polycarboxylic acid compound, other than terephthalic acid and metal-sulfonate-group-containing polycarboxylic acid compound, as a polycarboxylic acid component; setting the respective proportions of the recycled polyester and metal-sulfonate-group-containing polycarboxylic acid compound to use within particular ranges; and making the acid value of the water-based polyester resin equal to or less than a particular value. That is to say, the production method (X) enables producing a water-based polyester resin having the above-described advantageous features. Specifically, the water-based polyester resin exhibits not only excellent water dispersibility even in the absence of any surfactant, for example, but also good stability when used as a resin dispersion liquid while reducing the environmental load. In addition, the water-based polyester resin includes a terephthalic acid residue derived from a recycled polyester and still has as good resin properties (such as adhesion and transparency) as in a situation where terephthalic acid or a terephthalic acid derivative not derived from a recycled polyester is used. Furthermore, the resin dispersion liquid of the water-based polyester resin not only exhibits good water dispersibility for a long term but also has improved stability such as aging stability in solution haze.

These advantages are achieved presumably for the following reasons, for example. Firstly, setting the proportion of the recycled polyester used at a certain value or more enables cutting down the amounts of materials derived from fossil fuels for use and reducing the wastes, for example, thus contributing to reducing the environmental load. In addition, a resin dispersion liquid of the water-based polyester resin to be produced may be prepared using either water or water containing a hydrophilic organic solvent and without using any surfactant, for example, which also contributes to reducing the environmental load. Furthermore, the water-based polyester resin may have its crystallinity decreased to an adequate degree while striking a proper balance in proportion between the hydrophobic and hydrophilic parts of the water-based polyester resin by using an additional polycarboxylic acid compound, setting the proportion of the recycled polyester used at a certain value or less, setting the proportion of the metal-sulfonate-group-containing polycarboxylic acid compound used within a particular range, and setting the acid value of the water-based polyester resin at a particular value or less. This and other measures taken according to this embodiment would allow the water-based polyester resin to have excellent water dispersibility even in the absence of any surfactant, for example, and improve the stability of the resin dispersion liquid thereof. It is not perfectly clear why these advantages are achieved by setting the acid value at a particular value or less. One imaginable reason is that reducing interaction between resin molecules of the water-based polyester resin that has a carboxyl group on a side chain or an end of its molecules would contribute to improving the water dispersibility of the water-based polyester resin and the stability of the resin dispersion liquid thereof. Another imaginable reason is that using an additional polycarboxylic acid compound as a polycarboxylic acid component in the production method (X) enables causing the depolymerization reaction appropriately to recycled polyesters with various molecular weights. Furthermore, for the same reasons why the above-described water-based polyester resin has excellent water dispersibility and its resin dispersion liquid has good stability, the resin properties such as adhesion and transparency, the water dispersibility for a long term, and its stability such as aging stability in solution haze would also be improved equally significantly, no matter whether the terephthalic acid residue is derived from the recycled polyester or formed out of unused terephthalic acid or terephthalic acid derivative.

The water-based polyester resin produced by the production method (X) (hereinafter also referred to as “resin (Y)”) is a polyester resin and has a structural unit consisting of a polycarboxylic acid residue and a structural unit consisting of a polyalcohol residue. The polycarboxylic acid residue contained in either the resin (Y) or the polycarboxylic acid component is usually expressed by the following formula (1). The polyalcohol residue included in either the resin (Y) or polyalcohol component is usually expressed by the following formula (2). The resin (Y) has a terephthalic acid residue derived from the recycled polyester as a structural unit consisting of a polycarboxylic acid residue.

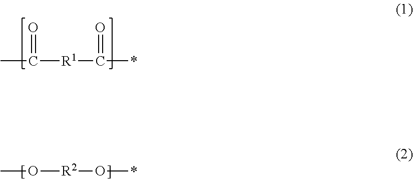

In formula (1), R¹ is a substituted or non-substituted hydrocarbon group having 1 to 50 carbon atoms.

In formula (2), R² is a substituted or non-substituted hydrocarbon group having 1 to 50 carbon atoms.

In formulae (1) and (2), * indicates a group adjacent to the residue expressed by formula (1) or (2) or a site that bonds to the adjacent residue.

Examples of substituents for the hydrocarbon groups in R¹ and R² include hydroxy groups such as an alcoholic hydroxy group and a phenolic hydroxy group, a carboxy group, an acyl group, an acyloxy group, a halogen atom, an alkoxy group, and an alkoxy carbonyl group.

Next, the respective steps will be described.

[First Step]

The first step includes causing an ester formation reaction and a depolymerization reaction using, as reaction materials, a recycled polyester, a polycarboxylic acid component, and a polyalcohol component.

As used herein, the “ester formation reaction” refers to a reaction through which a polycarboxylic acid component and a polyalcohol component form an ester compound by, for example, dehydration condensation or dealcoholization condensation.

The depolymerization reaction as used herein refers to a reaction of forming a polyester with a lower molecular weight from a recycled polyester and a polycarboxylic acid component, a polyalcohol component, or an ester compound formed therefrom.

In the first step, all components of the reaction materials may be compounded at a time, or one or more components or a certain amount of components that form part of the reaction materials may be compounded sequentially. Alternatively, after some of the reaction materials have been compounded and then the reaction is caused, some others of the reaction materials may be compounded, and then the reaction may be further caused. These compounding and reaction processes may be repeated.

In the first step, after the recycled polyester, the polycarboxylic acid component, and the polyalcohol component have been compounded with each other, the ester formation reaction and the depolymerization reaction may be caused. Alternatively, after the polycarboxylic acid component and the polyalcohol component have been compounded with each other, the ester formation reaction may be caused, the recycled polyester may be added thereto, and then the depolymerization reaction may be caused.

The reaction materials are usually compounded in an apparatus, such as a reactor, for performing the production method (X).

The respective reaction materials will be described one by one below.

(Recycled Polyester)

The recycled polyester contains polyethylene terephthalate as a main component thereof. As used herein, the “main component” refers to a component with the largest content ratio. The proportion of polyethylene terephthalate with respect to the recycled polyester is preferably equal to or greater than 90% by mass, more preferably equal to or greater than 95% by mass, and even more preferably equal to or greater than 99% by mass. This enables turning the water-based polyester resin into a substantially mono material. The proportion may even be 100% by mass.

Examples of the recycled polyester include material recycled polyesters, mechanically recycled polyesters, and chemically recycled polyesters. As used herein, the “material recycled polyester” refers to a polyester obtained by subjecting used or waste polyester molded products such as bottles, containers, and films to sorting, pulverization, washing, and other processes for removing contaminants and foreign particles and then turning these products thus treated into flakes. As used herein, the “mechanically recycled polyester” refers to a polyester, from which contaminants inside the resin have been removed by treating those flakes of the material recycled polyester under a high-temperature and reduced-pressure environment, for example, for a certain period of time and of which the degree of polymerization is adjusted by repolymerizing a part of the polyester. As used herein, the “chemically recycled polyester” refers to a polyester obtained by decomposing a polyester down to the monomer level and then repolymerizing the monomers.

The intrinsic viscosity (IV value, unit: dl/g) of the recycled polyester is preferably equal to or greater than 0.40 and equal to or less than 1.20, and more preferably equal to or greater than 0.45 and equal to or less than 1.00, to cause the depolymerization reaction more appropriately in the second step. The intrinsic viscosity is generally used as an index to the degree of polymerization of a polymer.

The recycled polyester preferably contains at least one of the material recycled polyester or the mechanically recycled polyester from the viewpoint of further reducing the environmental load, and more preferably contains the mechanically recycled polyester from the viewpoint of improving the quality of the water-based polyester resin. The recycled polyester even more preferably contains a mechanically recycled polyester obtained by recovering PET bottles or PET films.

(Polycarboxylic Acid Component)

The polycarboxylic acid component is a compound containing a polycarboxylic acid residue other than terephthalic acid. The polycarboxylic acid component provides a structural unit consisting of a polycarboxylic acid residue in the resin (Y).

The polycarboxylic acid component includes at least one selected from the group consisting of polycarboxylic acids, each having a metal sulfonate group, and their esters and anhydrides (hereinafter also referred to as “metal-sulfonate group-containing polycarboxylic acid compounds (A)”). In addition, the polycarboxylic acid component also includes at least one selected from the group consisting of polycarboxylic acids other than the metal-sulfonate-group-containing polycarboxylic acid compounds (A) and terephthalic acid and their esters and anhydrides (hereinafter referred to as “additional polycarboxylic acid compounds (B)”).

(Metal-Sulfonate-Group-Containing Polycarboxylic Acid Compound)

The metal-sulfonate-group-containing polycarboxylic acid compound (A) is at least one compound selected from the group consisting of polycarboxylic acids, each having a metal sulfonate group, and their esters and anhydrides. The metal-sulfonate-group-containing polycarboxylic acid compound (A) includes a metal-sulfonate-group-containing polycarboxylic acid residue. The metal-sulfonate-group-containing polycarboxylic acid compound (A) provides a structural unit consisting of a metal-sulfonate-group-containing polycarboxylic acid residue in the resin (Y).

As used herein, the “metal sulfonate group” refers to a metal base of a sulfo group (—SO₃H), and may be expressed by, for example, —SO₃— (Mⁿ⁺)_{1/n} (where Mⁿ⁺ is an n-valent metal cation, and n is an integer falling within the range from 1 to 6). In this case, n preferably falls within the range from 1 to 3, is more preferably either 1 or 2, and is even more preferably 1. Examples of metal cations include: monovalent metal cations such as alkali metal ions including a lithium ion, a sodium ion, a potassium ion, a rubidium ion, and a cesium ion; and divalent metal cations such as alkaline earth metal ions including a magnesium ion, a calcium ion, a strontium ion, and a barium ion. The metal-sulfonate-group-containing polycarboxylic acid compound (A) may have one, two or more metal sulfonate groups, but preferably has a single metal sulfonate group.

Examples of the metal-sulfonate-group-containing polycarboxylic acid compound (A) include compounds in which one or more metal sulfonate groups are bonded to a hydrocarbon group included in a polycarboxylic acid compound. The metal-sulfonate-group-containing polycarboxylic acid compound (A) preferably includes a polycarboxylic acid compound having a single metal sulfonate group.

Examples of the metal-sulfonate-group-containing polycarboxylic acid compound (A) include sulfoisophthalates such as 2-sulfoisophthalate, 4-sulfoisophthalate, and 5-sulfoisophthalate, aromatic dicarboxylates such as a 4-sulfo-2,6-naphthalene dicarboxylate, and esters and anhydrides thereof.

The metal-sulfonate-group-containing polycarboxylic acid compound (A) preferably contains at least one selected from the group consisting of aromatic dicarboxylates and esters and anhydrides thereof. The metal-sulfonate-group-containing polycarboxylic acid compound (A) more preferably contains at least one selected from the group consisting of sulfobenzene dicarboxylates and esters and anhydrides thereof. The metal-sulfonate-group-containing polycarboxylic acid compound (A) even more preferably contains at least one selected from the group consisting of 5-sulfoisophthalate and esters and anhydrides thereof.

(Additional Polycarboxylic Acid Compound)

The additional polycarboxylic acid compound(s) (B) is at least one compound selected from the group consisting of polycarboxylic acid compounds other than terephthalic acid and metal-sulfonate-group-containing polycarboxylic acids and their esters and anhydrides. The additional polycarboxylic acid compound(s) (B) includes a polycarboxylic acid residue other than a terephthalic acid residue and a metal-sulfonate-group-containing polycarboxylic acid residue. The additional polycarboxylic acid compound (B) provides a structural unit consisting of the additional polycarboxylic acid residue in the resin (Y).

Examples of the additional polycarboxylic acid compound(s) (B) include at least one selected from the group consisting of: aromatic dicarboxylic acids such as phthalic acid, isophthalic acid, 2,6-naphthalene dicarboxylic acid, 2,7-naphthalene dicarboxylic acid, 1,4-naphthalene dicarboxylic acid, and 2,5-furan dicarboxylic acid; alicyclic dicarboxylic acids such as 1,4-cyclohexane dicarboxylic acid: dicarboxylic acids such as aliphatic dicarboxylic acids including succinic acid, adipic acid, sebacic acid, and dodecane dioic acid; and esters and anhydrides thereof.

Examples of the additional polycarboxylic acid compound(s) (B) further include at least one selected from the group consisting of: aromatic tricarboxylic acids such as trimellitic acid, hemimellitic acid, trimesic acid, and 1,2,5-naphthalene tricarboxylic acid; alicyclic tricarboxylic acids such as a 1,2,4-cyclohexane tricarboxylic acid; aliphatic tricarboxylic acids such as a 1,2,3-butane tricarboxylic acid: trivalent or higher valent polycarboxylic acids such as pyromellitic acid; and esters and anhydrides thereof.

From the viewpoint of reducing the environmental load, it is also preferable to use a biomass-derived polycarboxylic acid compound (B). Examples of the biomass-derived polycarboxylic acid compound (B) include 2,5-furan dicarboxylic acid, succinic acid, adipic acid, and sebacic acid.

The additional polycarboxylic acid compound(s) (B) preferably contains at least one selected from the group consisting of dicarboxylic acids and esters and anhydrides thereof. More preferably, the additional polycarboxylic acid compound(s) (B) contains at least one selected from the group consisting of dicarboxylic acids having no functional groups but a carboxy group, and esters and anhydrides thereof.

The additional polycarboxylic acid compound(s) (B) preferably contains, from the viewpoint of further improving the water dispersibility of the water-based polyester resin and the stability of the resin dispersion liquid thereof by more adequately lowering the degree of crystallinity of the water-based polyester resin, at least one selected from the group consisting of aromatic dicarboxylates and esters and anhydrides thereof, and more preferably contains at least one selected from the group consisting of isophthalic acid and 2,6-naphthalene dicarboxylic acid.

(Polyalcohol Component)

The polyalcohol component is a compound containing a polyalcohol residue. The resin (Y) usually has, as a polyalcohol residue, an ethylene glycol residue derived from a recycled polyester.

Examples of the polyalcohol component include: diol compounds including: aliphatic diols such as ethylene glycol, 1,2-propanediol, 1,3-propanediol, 1,3-butanediol, 1,4-butanediol, neopentyl glycol, and 1,6-hexanediol; alicyclic diols such as 1,4-cyclohexanedimethanol; aromatic diols such as 1,4-benzenedimethanol and 9,9-bis[4-(2-hydroxyethoxy)phenyl]fluorene; and ether-group-containing diols including diethylene glycol, polyethylene glycol, dipropylene glycol, polypropylene glycol, and polytetramethylene ether glycol.

Examples of the polyalcohol component further include trihydric or higher hydric polyalcohol compounds. Examples of the trihydric or higher hydric polyalcohol compounds include triol compounds including: aliphatic triols such as glycerin and trimethylolpropane; alicyclic triols such as 1,2,4-cyclohexanetrimethanol; and aromatic triols such as benzene trimethanol; and pentaerythritol.

The polyalcohol component preferably includes a polyalcohol compound other than ethylene glycol (hereinafter also referred to as an “additional polyalcohol compound(s)”). This may further increase the adhesion of a resin film of the resin (Y) to a resin, metal, or any other material having a polar structure. The additional polyalcohol compound preferably includes at least one selected from the group consisting of diol compounds and triol compounds having no functional groups but a hydroxy group, and more preferably includes a diol compound having no functional groups but a hydroxy group. The additional polyalcohol compound preferably includes at least one selected from the group consisting of diethylene glycol, polyethylene glycol, 1,2-propanediol, 1,3-propanediol, 1,3-butanediol, 1,4-butanediol, neopentyl glycol, 1,6-hexane diol, 1,4-cyclohexanedimethanol, and trimethylolpropane. The additional polyalcohol compound more preferably includes at least one selected from the group consisting of diethylene glycol, 1,2-propanediol, 1,3-propanediol, 1,3-butanediol, 1,4-butanediol, neopentyl glycol, 1,6-hexanediol, and 1,4-cyclohexanedimethanol.

From the viewpoint of reducing the environmental load, it is also preferable to use a biomass-derived polyalcohol component. Examples of the biomass-derived polyalcohol component include ethylene glycol, 1,3-propanediol, 1,3-butanediol, and 1,4-butanediol.

It is important to use, in the first step, the recycled polyester to such an amount that makes the proportion of the terephthalic acid residue included in the recycled polyester with respect to the total of the terephthalic acid residue included in the recycled polyester and the polycarboxylic acid residue included in the polycarboxylic acid component equal to or greater than 20% by mass and equal to or less than 72% by mass. If the proportion were less than 20% by mass, the environmental load would be reduced insufficiently. If the proportion were greater than 72% by mass, the resin (Y) would not have a lower degree of crystallinity but have decreased water dispersibility. The proportion is preferably equal to or greater than 30% by mass, more preferably equal to or greater than 40% by mass, even more preferably equal to or greater than 45% by mass, and particularly preferably equal to or greater than 50% by mass. The proportion is preferably equal to or less than 71% by mass, more preferably equal to or less than 70% by mass, even more preferably equal to or less than 69% by mass, and particularly preferably equal to or less than 68% by mass.

It is also important to use, in the first step, the metal-sulfonate-group-containing polycarboxylic acid compound (A) to such an amount that makes the proportion of the metal-sulfonate-group-containing polycarboxylic acid residue included in the metal-sulfonate-group-containing polycarboxylic acid compound (A) with respect to the total of the terephthalic acid residue included in the recycled polyester and the polycarboxylic acid residue included in the polycarboxylic acid component equal to or greater than 5% by mass and equal to or less than 32% by mass. If the proportion were less than 5% by mass, the proportion of a hydrophilic part of the resin (Y) would be too small to avoid causing a decrease in water dispersibility. If the proportion were greater than 32% by mass, the proportion of the hydrophilic part of the rein (Y) would be so large as to cause tackiness often to the resin (Y) due to moisture absorption of the resin film. Furthermore, setting the proportion within the above-described particular range enables further improving the adhesion of the resin (Y) to a resin, a metal, or any other material having a polar structure. The proportion is preferably equal to or greater than 6% by mass, more preferably equal to or greater than 7% by mass, even more preferably equal to or greater than 8% by mass, and particularly preferably equal to or greater than 9% by mass. The proportion is preferably equal to or less than 31% by mass, more preferably equal to or less than 29% by mass, even more preferably equal to or less than 27% by mass, and particularly preferably equal to or less than 25% by mass.

The first step includes using the additional polycarboxylic acid compound (B) to such an amount that makes the proportion of the additional polycarboxylic acid residue included in the additional polycarboxylic acid compound (B) with respect to the total of the terephthalic acid residue included in the recycled polyester and the polycarboxylic acid residue included in the polycarboxylic acid component equal to or greater than 3% by mass and equal to or less than 55% by mass, for example. Setting the proportion within this range allows the resin (Y) to decrease the degree of crystallinity thereof more adequately and further improve the water dispersibility and the stability of the resin dispersion liquid thereof. The proportion is preferably equal to or greater than 5% by mass, more preferably equal to or greater than 10% by mass, even more preferably equal to or greater than 13% by mass, and particularly preferably equal to or greater than 15% by mass. The proportion is preferably equal to or less than 50% by mass, more preferably equal to or less than 42% by mass, even more preferably equal to or less than 30% by mass, and particularly preferably equal to or less than 25% by mass.

If the additional polycarboxylic acid compound(s) (B) includes a trivalent or higher valent polycarboxylic acid compound, the proportion of the trivalent or higher valent polycarboxylic acid compound with respect to the entire additional polycarboxylic acid compound(s) (B) is preferably equal to or less than 3% by mass. This allows the resin (Y) to further reduce the number of crosslinked structures formed due to the presence of the trivalent or higher valent polycarboxylic acid compound, and thereby further improve the water dispersibility and the stability of the resin dispersion liquid thereof. The proportion is more preferably equal to or less than 2% by mass, even more preferably equal to or less than 1% by mass, and particularly preferably equal to or less than 0.5% by mass. The proportion of the trivalent or higher valent polycarboxylic acid compound is preferably as small as possible and may even be 0% by mass.

The polycarboxylic acid component for use in the first step preferably includes no trivalent or higher valent polycarboxylic acid compounds. That is to say, the metal-sulfonate-group-containing polycarboxylic acid compound (A) to be used and the additional polycarboxylic acid compound (B) to be used preferably include no trivalent or higher valent polycarboxylic acid compounds, and preferably include only divalent polycarboxylic acid compounds. This enables further decreasing the acid value of the resin (Y). In addition, this also allows the resin (Y) to have a smaller number of crosslinked structures formed due to the presence of the trivalent or higher valent polycarboxylic acid compound. This enables further improving the water dispersibility of the resin (Y) and the stability of the resin dispersion liquid thereof.

If the polyalcohol component includes a trihydric or higher hydric polyalcohol compound, the proportion of the trihydric or higher hydric polyalcohol compound with respect to the entire polyalcohol component is preferably equal to or less than 5% by mass. This allows the resin (Y) to have a smaller number of crosslinked structures formed due to the presence of the trihydric or higher hydric polyalcohol compound. As a result, the water dispersibility and the stability of the resin dispersion liquid are further improvable. This proportion is more preferably equal to or less than 4% by mass, even more preferably equal to or less than 3% by mass, and particularly preferably equal to or less than 1% by mass. The proportion of the trihydric or higher hydric polyalcohol compound is preferably as small as possible and may even be 0% by mass. Thus, the polyalcohol component for use in the first step preferably includes no trihydric or higher hydric polyalcohol compound or includes a trihydric or higher hydric polyalcohol compound at a proportion equal to or less than 5% by mass with respect to the entire polyalcohol component used.

If the polyalcohol component includes a dihydric alcohol compound, the dihydric alcohol compound preferably has a branched chain. This allows the resin dispersion liquid of the resin (Y) to further improve its stability such as aging stability in solution haze.

If the polyalcohol component includes a dihydric alcohol compound having a branched chain, the proportion of the dihydric alcohol compound having the branched chain with respect to the entire polyalcohol component is preferably equal to or greater than 5% by mass and equal to or less than 50% by mass. This allows the resin dispersion liquid of the resin (Y) to further improve its stability such as aging stability in solution haze. The proportion is preferably equal to or greater than 10% by mass and equal to or less than 45% by mass, more preferably equal to or greater than 15% by mass and equal to or less than 40% by mass, and even more preferably equal to or greater than 20% by mass and equal to or less than 35% by mass.

If the polyalcohol component includes a polyalcohol compound other than ethylene glycol, the proportion of ethylene glycol with respect to the entire polyalcohol component is preferably equal to or greater than 50% by mass. This enables promoting the depolymerization reaction of the recycled polyester. The proportion is more preferably equal to or greater than 60% by mass, even more preferably equal to or greater than 70% by mass, and particularly preferably equal to or greater than 80% by mass. The proportion may even be 100% by mass. That is to say, from the viewpoint of promoting the depolymerization reaction of the recycled polyester, the proportion of the additional polyalcohol compound with respect to the entire polyalcohol component is preferably equal to or less than 50% by mass, more preferably equal to or less than 40% by mass, even more preferably equal to or less than 30% by mass, and particularly preferably equal to or less than 20% by mass. The proportion may even be 0% by mass.

In the first step, more moles of the polyalcohol component are preferably used than the polycarboxylic acid component. This enables further promoting the depolymerization reaction of the recycled polyester. In addition, this also enables decreasing the acid value of the resin (Y) and further improving the water dispersibility of the resin (Y) and the stability of the resin dispersion liquid thereof. Specifically, the molar ratio of the polyalcohol component to the polycarboxylic acid component (polyalcohol component/polycarboxylic acid component) is preferably equal to or greater than 1.5 to 1 and equal to or less than 5 to 1. The molar ratio of the polyalcohol component to the polycarboxylic acid component is more preferably equal to or greater than 1.6 to 1 and equal to or less than 4.7 to 1, even more preferably equal to or greater than 1.8 to 1 and equal to or less than 4.5 to 1, and particularly preferably equal to or greater than 2.0 to 1 and equal to or less than 4.2 to 1.

From the viewpoint of reducing the environmental load, the proportion of the recycled polyester used with respect to the total amount of materials used for producing the water-based polyester resin is preferably as large as possible. Specifically, in the first step, the recycled polyester is preferably used to such an amount that makes the proportion of the recycled polyester with respect to the total of the recycled polyester, the polycarboxylic acid component, and the polyalcohol component equal to or greater than 20% by mass and equal to or less than 70% by mass. The proportion is more preferably equal to or greater than 30% by mass, and even more preferably equal to or greater than 40% by mass. The proportion is more preferably equal to or less than 65% by mass, and even more preferably equal to or less than 62% by mass.

Also, from the viewpoint of reducing the environment load, the proportion of the polyalcohol component used with respect to the total amount of materials used for producing the water-based polyester resin is preferably as small as possible. Specifically, in the first step, the polyalcohol component is preferably used to such an amount that makes the proportion of the polyalcohol component with respect to the total of the recycled polyester, the polycarboxylic acid component, and the polyalcohol component equal to or greater than 10% by mass and equal to or less than 40% by mass. The proportion is more preferably equal to or less than 35% by mass, and even more preferably equal to or less than 30% by mass. The proportion is more preferably equal to or greater than 13% by mass, and even more preferably equal to or greater than 15% by mass.

In the first step, the recycled polyester is preferably used to such an amount that makes the proportion of the recycled polyester with respect to the total of the recycled polyester and the polycarboxylic acid residue equal to or greater than 25% by mass and equal to or less than 85% by mass. The proportion is more preferably equal to or greater than 40% by mass, and even more preferably equal to or greater than 55% by mass. The proportion is more preferably equal to or less than 80% by mass, and even more preferably equal to or less than 78% by mass.

Furthermore, in the first step, the metal-sulfonate-group-containing polycarboxylic acid compound (A) is preferably used to such an amount that makes the proportion of the metal-sulfonate-group-containing polycarboxylic acid residue included in the metal-sulfonate-group-containing polycarboxylic acid compound (A) with respect to the total of the recycled polyester and the polycarboxylic acid residue equal to or greater than 4% by mass and equal to or less than 30% by mass. The proportion is more preferably equal to or greater than 5% by mass, and even more preferably equal to or greater than 6% by mass. The proportion is more preferably equal to or less than 28% by mass, and even more preferably equal to or less than 26% by mass.

In the first step, the additional polycarboxylic acid compound (B) is preferably used to such an amount that makes the proportion of the additional polycarboxylic acid residue included in the additional polycarboxylic acid compound (B) with respect to the total of the recycled polyester and the polycarboxylic acid residue equal to or greater than 1% by mass and equal to or less than 50% by mass. The proportion is more preferably equal to or greater than 4% by mass, and even more preferably equal to or greater than 10% by mass. The proportion is more preferably equal to or less than 40% by mass, and even more preferably equal to or less than 35% by mass.

In the first step, at least one selected from the group consisting of terephthalic acid and its esters and anhydrides and at least one selected from the group consisting of hydroxycarboxylic acid and its esters and anhydrides may be used besides the recycled polyester, the polycarboxylic acid component, and the polyalcohol component, as far as the advantages of the present disclosure are not impaired but are preferable not used.

The reaction in the first step may be promoted by, for example, heating the reaction materials compounded.

In the first step, it is preferable to use a catalyst from the viewpoint of promoting the reaction. Examples of the catalyst include titanium oxalate salts such as potassium titanium oxalate and sodium titanium oxalate; titanium alkoxides such as tetra-n-propyl titanate and tetra-n-butyl titanate; fatty acid titanium salts such as titanium acetate: titanium catalysts such as inorganic titanium compounds such as titanium oxides; fatty acid manganese salts such as manganese acetate; manganese catalysts such as manganese carbonate; antimony catalysts such as antimony trioxide; aluminum catalysts such as aluminum tris acetyl acetate; germanium catalysts such as germanium dioxide; and lithium catalysts such as sec-butyllithium.

The amount of the catalyst used may be, for example, equal to or greater than 0.0001% by mass and equal to or less than 0.1% by mass, and is preferably equal to or greater than 0.003% by mass and equal to or less than 0.05% by mass, with respect to all the components compounded in the first step.

To cause the reaction in the first step, a reaction solvent may or may not be used, but is preferably not used.

From the viewpoint of improving the quality of the resin (Y), the reaction in the first step is preferably caused in an inert gas atmosphere such as a nitrogen atmosphere or an argon atmosphere.

[Second Step]

The second step includes causing a polycondensation reaction by reducing pressure. In the second step, the polycondensation reaction is promoted by reducing the pressure in the reaction system and thereby removing the polyalcohol and other products produced by the reaction.

As used herein, the polycondensation reaction refers to a reaction, through which the ester compound formed in the first step and the polyester are subjected to, for example, a dealcoholization condensation reaction to form a polyester having a higher molecular weight.

The reaction in the second step may be promoted by reducing the pressure in the reaction system and by, for example, heating the reaction product produced in the first step.

After the reaction has been caused in the first step, the second step may be performed with the pressure in the reaction system kept reduced but with the temperature adjusted. Alternatively, the second step may also be performed by isolating the reaction product produced in the first step, adding a catalyst, a solvent, or any other additive thereto as needed, and then reducing the pressure in the reaction system and heating the reaction product, for example.

The water-based polyester resin (resin (Y)) is produced by performing the production method (X) as described above.

(Acid Value)

It is important that the resin (Y) thus obtained has an acid value equal to or less than 10 mgKOH/g. Setting the acid value of the resin (Y) at a value equal to or less than 10 mgKOH/g enables significantly improving the water dispersibility and the stability of the resin dispersion liquid. If the acid value of the resin (Y) were greater than 10 mgKOH/g, the water dispersibility of the resin (Y) and the stability of the resin dispersion liquid would both decrease. The acid value is preferably equal to or less than 9 mgKOH/g, more preferably equal to or less than 8 mgKOH/g, even more preferably equal to or less than 7 mgKOH/g, and particularly preferably equal to or less than 6 mgKOH/g. The smaller the acid value of the resin (Y) is, the better. The acid value of the resin (Y) may even be 0 mgKOH/g. As used herein, the “acid value” of the resin (Y) refers to the mass (mg) of potassium hydroxide required to neutralize 1 g of the resin (Y). The acid value of the resin (Y) is a value determined by, for example, the presence of a carboxy group on the side chain or end of a molecule of the resin (Y).

(Glass Transition Temperature)

The glass transition temperature (Tg) of the resin (Y) thus obtained is preferably equal to or higher than 0° C. and equal to or lower than 100° C. Setting Tg at a temperature equal to or higher than 0° C. reduces the chances of the resin (Y) being too viscous, thus making it even easier to handle the resin (Y) and further reducing the chances of causing excessive tackiness. Setting Tg at a temperature equal to or lower than 100° C. allows the resin (Y) to have better film-forming ability and enables further increasing the adhesion of the resin (Y) to a base member and improving primer properties thereof. Tg is more preferably equal to or higher than 10° C. and even more preferably equal to or higher than 20° C. Tg is more preferably equal to or lower than 80° C. and even more preferably equal to or lower than 75° C.

The weight average molecular weight of the resin (Y) thus obtained is preferably equal to or greater than 3,000 and equal to or less than 100,000, more preferably equal to or greater than 5,000 and equal to or less than 80,000, and even more preferably equal to or greater than 6,000 and equal to or less than 60,000.

Exemplary implementations of the production method (X) according to this embodiment include the production method (X1) and production method (X2) to be described below.

[Production Method (X1)]

According to the production method (X1), the resin (Y) is produced by performing, after having compounded the recycled polyester, the polycarboxylic acid component, and the polyalcohol component with each other as reaction materials, the step of causing an ester formation reaction and a depolymerization reaction to the reaction materials thus compounded (hereinafter referred to as a “step X1-1”) and the step of causing a polycondensation reaction by reducing the pressure in the reaction system (hereinafter referred to as a “step X1-2”). The production method (X1) enables producing the water-based polyester resin by a simpler method.

(Step X1-1)

The step X1-1 includes compounding the recycled polyester, the polycarboxylic acid component, and the polyalcohol component and then causing an ester formation reaction and a depolymerization reaction.

The reaction temperature in the step X1-1 is preferably equal to or higher than 150° C. and equal to or lower than 270° C., and more preferably equal to or higher than 180° C. and equal to or lower than 260° C. The reaction time is preferably equal to or longer than 1 hour and equal to or shorter than 10 hours, and more preferably equal to or longer than 2 hours and equal to or shorter than 8 hours. From the viewpoint of further promoting the ester formation reaction and depolymerization reaction in the step X1-1, the reaction system is preferably under ordinary pressure. The reaction temperature in the step X1-1 may be changed stepwise.

(Step X1-2)

The step X1-2 includes causing a polycondensation reaction by reducing the pressure. The step X1-2 is the same as the second step described above.

The reaction temperature in the step X1-2 is preferably equal to or higher than 150° C. and equal to or lower than 270° C., and more preferably equal to or higher than 200° C. and equal to or lower than 260° C. The degree of pressure reduction (absolute pressure) in the step X1-2 is preferably equal to or lower than 25 hPa, and more preferably equal to or lower than 10 hPa. The reaction temperature and degree of pressure reduction in the step X1-2 may be changed stepwise. Adjusting the reaction temperature, reaction time, and degree of pressure reduction in the step X1-2 allows the weight average molecular weight or any other parameter of resin (Y) to be adjusted.

[Production Method (X2)]

The production method (X2) may be a method including: the step of causing, after having compounded a polycarboxylic acid component and a polyalcohol component as reaction materials, an ester formation reaction to the reaction materials thus compounded (hereinafter also referred to as a “step X2-1”): the step of compounding a recycled polyester with the reaction product produced in the step X2-1 and then causing a depolymerization reaction (hereinafter also referred to as a “step X2-2”); and the step of causing a polycondensation reaction by reducing the pressure (hereinafter also referred to as a “step X2-3”). Performing the compounding and reaction processes separately in these steps X2-1 to X2-3 enables, for example, causing a depolymerization reaction of the recycled polyester more appropriately, and further improving the water dispersibility of the water-based polyester resin and the stability of the resin dispersion liquid thereof.

(Step X2-1)

The step X2-1 includes causing an ester formation reaction after having compounded the polycarboxylic acid component and the polyalcohol component with each other.

The reaction temperature in the step X2-1 is preferably equal to or higher than 150° C. and equal to or lower than 250° C., and more preferably equal to or higher than 180° C. and equal to or lower than 240° C. The reaction time is preferably equal to or longer than 1 hour and equal to or shorter than 8 hours, and more preferably equal to or longer than 2 hours and equal to or shorter than 5 hours. From the viewpoint of further promoting the ester formation reaction in the step X2-1, the reaction system is preferably under ordinary pressure. The reaction temperature in the step X2-1 may be changed stepwise.

(Step X2-2)

The step X2-2 includes further adding the recycled polyester to the reaction product and then causing a depolymerization reaction to the compound.

The reaction temperature in the step X2-2 is preferably equal to or higher than 200° C. and equal to or lower than 270° C., and more preferably equal to or higher than 210° C. and equal to or lower than 260° C. The reaction time is preferably equal to or longer than 1 hour and equal to or shorter than 8 hours, and more preferably equal to or longer than 2 hours and equal to or shorter than 5 hours. From the viewpoint of further promoting the depolymerization reaction in the step X2-2, the reaction system is preferably under ordinary pressure. The reaction temperature in the step X2-2 may be changed stepwise.

(Step X2-3)

The step X2-3 includes causing a polycondensation reaction by reducing the pressure. The step X2-3 is the same as the second step described above.

The reaction temperature in the step X2-3 is preferably equal to or higher than 150° C. and equal to or lower than 270° C., and more preferably equal to or higher than 200° C. and equal to or lower than 260° C. The degree of pressure reduction (absolute pressure) in the step X2-3 is preferably equal to or lower than 25 hPa, and more preferably equal to or lower than 10 hPa. The reaction temperature and degree of pressure reduction in the step X2-3 may be changed stepwise. Adjusting the reaction temperature, reaction time, and degree of pressure reduction in the step X2-3 enables adjusting the weight average molecular weight or any other parameter of the resin (Y).

<Water-Based Polyester Resin>

The resin (Y) according to this embodiment is produced by the production method (X) described above.

Another resin (Y) according to this embodiment includes a terephthalic acid residue derived from a recycled polyester (hereinafter also referred to as a “residue (I)”) and a polycarboxylic acid residue other than the terephthalic acid residue (hereinafter also referred to as a “residue (II)”). The residue (II) includes a metal-sulfonate-group-containing polycarboxylic acid residue (hereinafter also referred to as a “residue (IIa)”) and an additional polycarboxylic acid residue other than the residues (I) and (IIa) (hereinafter also referred to as a “residue (IIb)”). The proportion of the residue (I) is equal to or greater than 20% by mass and equal to or less than 72% by mass, and the proportion of the residue (IIa) is equal to or greater than 5% by mass and equal to or less than 32% by mass, with respect to the entire polycarboxylic acid residue included in the resin (Y). The resin (Y) has an acid value equal to or less than 10 mgKOH/g.

The resin (Y) exhibits not only excellent water dispersibility even in the absence of any surfactant, for example, but also good stability when used as a resin dispersion liquid, while reducing the environmental load. The resin (Y) uses, as a material thereof, the recycled polyester, of which the proportion is equal to or greater than a certain value, thus enabling cutting down the amounts of materials derived from fossil fuels for use and reducing the wastes, for example, and thereby reducing the environmental load. In addition, the resin (Y) includes a terephthalic acid residue derived from the recycled polyester, a metal-sulfonate-group-containing polycarboxylic acid residue, and an additional polycarboxylic acid residue. The resin (Y) may have its crystallinity decreased to an adequate degree while striking a proper balance in proportion between the hydrophobic and hydrophilic parts of the resin (Y) by setting the proportions of the terephthalic acid residue and the metal-sulfonate-group-containing polycarboxylic acid residue within particular ranges and setting the acid value at a particular value or less. This and other measures taken according to this embodiment would allow the resin (Y) to have excellent water dispersibility even without any surfactant, for example, and improve the stability of the resin dispersion liquid thereof. Furthermore, the resin (Y) includes a residue of terephthalic acid derived from the recycled polyester and still has as good resin properties (such as adhesion and transparency) as in a situation where unused terephthalic acid or terephthalic acid derivative not derived from the recycled polyester is used. In addition, the resin dispersion liquid of the resin (Y) not only exhibits good water dispersibility for a long term but also improves its stability such as aging stability in solution haze. It is not perfectly clear why these advantages are achieved. But these advantages are achieved presumably for the following reasons, for example. As described above, the resin (Y) may have its crystallinity decreased to an adequate degree while striking a proper balance in proportion between the hydrophobic and hydrophilic parts of the resin (Y) by setting the proportions of the respective residues and the acid value within the particular ranges. For the same reasons why the resin (Y) has excellent water dispersibility and its resin dispersion liquid has good stability, the resin properties such as adhesion and transparency, the water dispersibility for a long term, and its stability such as stability in solution haze would also be improved equally significantly, no matter whether the terephthalic acid residue is derived from the recycled polyester or formed out of unused terephthalic acid or terephthalic acid derivative.

The resin (Y) includes a polycarboxylic acid residue and a polyalcohol residue.

(Polycarboxylic Acid Residue)

The resin (Y) includes the residue (I) and the residue (II) as the polycarboxylic acid residues.

(Residue (I))

The residue (I) is a terephthalic acid residue derived from the recycled polyester. As used herein, the “terephthalic acid residue derived from the recycled polyester” means that the terephthalic acid residue included in the recycled polyester has turned into a terephthalic acid residue included in the resin (Y). As used herein, the “terephthalic acid residue” refers to a residue expressed by the following formula (3):

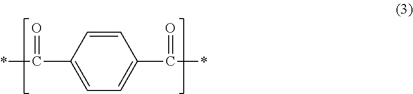

In the formula (3), * indicates either a group adjacent to the residue expressed by this formula (3) or a site bonding to an adjacent residue.

It is important that the proportion of the residue (I) with respect to the entire polycarboxylic acid residue in the resin (Y) is equal to or greater than 20% by mass and equal to or less than 72% by mass. If the proportion were less than 20% by mass, the environmental load would be reduced insufficiently. If the proportion were greater than 72% by mass, the crystallinity of the resin (Y) would not decrease, thus causing a decline in the water dispersibility and the stability of the resin dispersion liquid. The proportion is preferably equal to or greater than 30% by mass, more preferably equal to or greater than 40% by mass, even more preferably equal to or greater than 45% by mass, and particularly preferably equal to or greater than 50% by mass. The proportion is preferably equal to or less than 71% by mass, more preferably equal to or less than 70% by mass, even more preferably equal to or less than 69% by mass, and particularly preferably equal to or less than 68% by mass. As used herein, the “entire polycarboxylic acid residue” of resin (Y) refers to, for example, the sum of the residue (I) and the residue (II).

(Residue (II))

The residue (II) includes a residue (IIa) and a residue (IIb).

(Residue (IIa))

The residue (IIa) is a metal-sulfonate-group-containing polycarboxylic acid residue.

It is important that the proportion of the residue (IIa) with respect to the entire polycarboxylic acid residue in the resin (Y) is equal to or greater than 5% by mass and equal to or less than 32% by mass. If the proportion were less than 5% by mass, the proportion of the hydrophilic part would be too small to avoid causing a decline in water dispersibility. If the proportion were greater than 32% by mass, then the proportion of the hydrophilic part would be so large as to cause tackiness frequently due to the absorption of moisture into the resin film of the resin (Y). The proportion is preferably equal to or greater than 6% by mass, more preferably equal to or greater than 7% by mass, even more preferably equal to or greater than 8% by mass, and particularly preferably equal to or greater than 9% by mass. The proportion is preferably equal to or less than 31% by mass, more preferably equal to or less than 29% by mass, even more preferably equal to or less than 27% by mass, and particularly preferably equal to or less than 25% by mass.

(Residue (IIb))

The residue (IIb) is a polycarboxylic acid residue other than the residue (I) and the residue (IIa).

The proportion of the residue (IIb) with respect to the entire polycarboxylic acid residue in the resin (Y) is preferably equal to or greater than 3% by mass and equal to or less than 55% by mass. The proportion is more preferably equal to or greater than 5% by mass, even more preferably equal to or greater than 10% by mass, particularly preferably equal to or greater than 13% by mass, and most preferably equal to or greater than 15% by mass. The proportion is more preferably equal to or less than 50% by mass, even more preferably equal to or less than 40% by mass, particularly preferably equal to or less than 30% by mass, and most preferably equal to or less than 25% by mass.

The resin (Y) may further include, as an additional polycarboxylic acid residue, a terephthalic acid residue not derived from the recycled polyester besides the residues (I), (IIa), and (IIb). However, from the viewpoint of reducing the environmental load, it is preferable that the resin (Y) include no terephthalic acid residues not derived from the recycled polyester. Moreover, although the resin (Y) may include a hydroxycarboxylic acid residue, it is preferable that the resin (Y) include no hydroxycarboxylic acid residues.

The polycarboxylic acid residue preferably includes no residues of a trivalent or higher valent polycarboxylic acid compound. In other words, it is preferable that the residue (IIa) and the residue (IIb) include no residues included in the trivalent or higher valent polycarboxylic acid compound and includes only a residue of a divalent polycarboxylic acid compound. This enables further decreasing the acid value of the resin (Y) and also allows the resin (Y) to have a smaller number of crosslinked structures formed due to the presence of the trivalent or higher valent polycarboxylic acid compound. Consequently, the water dispersibility of the resin (Y) and the stability of the resin dispersion liquid are further improvable.

(Polyalcohol Residue)

The polyalcohol residue is a residue included in a polyalcohol compound having a plurality of alcoholic hydroxy groups. The resin (Y) usually has, as a polyalcohol residue, an ethylene glycol residue derived from a recycled polyester.

If the polyalcohol residue includes no residues of a trihydric or higher hydric polyalcohol compound or includes a residue of a trihydric or higher hydric polyalcohol compound, the proportion of the residue of the trihydric or higher hydric polyalcohol compound is preferably equal to or less than 5% by mass with respect to the entire polyalcohol residue included in the resin (Y). That is to say, even if the polyalcohol residue includes no residues included in a trihydric or higher hydric polyalcohol compound but includes only a dihydric polyalcohol compound residue or if the polyalcohol residue includes a residue included in a trihydric or higher hydric polyalcohol compound, the proportion of the residue included in the trihydric or higher hydric polyalcohol compound is preferably equal to or less than 5% by mass with respect to the entire residue of the polyalcohol compound. This allows the resin (Y) to have an adequate number of crosslinked structures, thus enabling further improving the water dispersibility of the resin (Y) and the stability and film-forming ability of the resin dispersion liquid thereof. The proportion of the residue of the trihydric or higher hydric polyalcohol compound is more preferably equal to or less than 4% by mass, and even more preferably equal to or less than 3% by mass, with respect to the entire polyalcohol residue included in the resin (Y).

If the polyalcohol residue includes a residue of a dihydric alcohol compound, then the residue of the dihydric alcohol compound preferably has a branched chain. This allows the resin dispersion liquid of the resin (Y) to further improve its stability such as aging stability in solution haze.

Examples of the dihydric alcohol compound having a branched chain include a compound expressed by the following formula (4):

HO—R³—OH (4)

In formula (4), R³ is a branched-chain divalent hydrocarbon group having 3 to 50 carbon atoms.

Examples of the branched-chain divalent hydrocarbon group represented by R³ include a propane-1,2-diyl group, a butane-1,2-diyl group, a butane-1,3-diyl group, a 2-methylpropane-1,3-diyl group, a pentane-1,2-diyl group, a pentane-1,3-diyl group, a pentane-1,4-diyl group, a 2,2-dimethylpropane-1,3-diyl group, a 2-methylbutane-1,4-diyl group, a hexane-1,2-diyl group, a hexane-2,5-diyl group, and a 2,4-diethylpentane-1,5-diyl group.

Examples of the branched-chain dihydric alcohol compound include neopentyl glycol, 1,2-propanediol, 1,2-butanediol, 1,3-butanediol, 1,2-pentanediol, 1,2-hexanediol, 2,5-hexanediol, and 2,4-diethyl-1,5-pentanediol. Among other things, neopentyl glycol, 1,2-propanediol, and 1,3-butanediol are particularly preferred.

The proportion of the dihydric alcohol compound residue having a branched chain is preferably equal to or greater than 5% by mass and equal to or less than 50% by mass with respect to the entire polyalcohol residue included in the resin (Y). This allows the resin dispersion liquid of the resin (Y) to further improve its stability such as aging stability in solution haze. The proportion is preferably equal to or greater than 10% by mass and equal to or less than 45% by mass, more preferably equal to or greater than 15% by mass and equal to or less than 40% by mass, and even more preferably equal to or greater than 20% by mass and equal to or less than 35% by mass.

<Water-Based Coating Composition>

A water-based coating composition according to this embodiment (hereinafter also referred to as “composition (Z)”) contains the resin (Y) described above.

The composition (Z) may contain, for example, either water or water containing a hydrophilic organic solvent. In that case, the applicability of the composition (Z) may be further increased by, for example, appropriately adjusting the viscosity of the composition (Z). If the composition (Z) contains either water or water containing a hydrophilic organic solvent, then the composition (Z) is a resin dispersion liquid of the resin (Y). This resin dispersion liquid of the resin (Y) is excellent in stability and may keep the resin dispersed for a long time.

Examples of the hydrophilic organic solvent include; alcohols such as methanol, ethanol, 2-propanol, and 1,2-propanediol: glycol ethers such as propylene glycol monomethyl ether, ethyl cellosolve, and n-butyl cellosolve: ketones such as acetone and methyl ethyl ketone.

The composition (Z) may be applied easily by, for example, bar coating, dip coating, spray coating, or spin coating.

The resin film made of the composition (Z) (hereinafter also referred to as a “resin film (W)”) has excellent adhesion to a resin having a polar structure such as a PET film and to a metal such as aluminum evaporated layers. In addition, the resin film (W) may also keep the haze low and is excellent in transparency. Furthermore, the resin film (W) is also excellent in primer properties, for example.

The composition (Z) may contain suitable additives such as an additional water-based resin other than the resin (Y), a leveling agent, an antioxidant, an ultraviolet absorber, an antifoaming agent, a cross-linking agent, and inorganic particles.

### EXAMPLES

Next, specific examples of the present disclosure will be described. Note that the examples to be described below are only examples of the present disclosure and should not be construed as limiting.

<Producing Water-Based Polyester Resin>

Using the materials shown in Tables 1 and 2 (to be posted later), a water-based polyester resin was produced in the following procedure. Details of the recycled polyester used for production are as follows:
Recycled polyester A: material recycled polyester made from recovered used PET bottles, having an intrinsic viscosity (IV value) of 0.88 dl/g;
Recycled polyester B: material recycled polyester made from recovered used PET bottles, having an intrinsic viscosity (IV value) of 0.67 dl/g;
Recycled polyester C: material recycled polyester made from recovered polyester fiber (PET fiber) wastes, having an intrinsic viscosity (IV value) of 0.59 dl/g; and
Recycled polyester D: material recycled polyester made from recovered PET film wastes, having an intrinsic viscosity (IV value) of 0.50 dl/g.

Note that the intrinsic viscosities (IV values) of the recycled polyesters were determined based on the results of measurement using an Ubbelohde viscometer.

The “intrinsic viscosity” as used herein refers to an intrinsic viscosity measured in compliance with the JIS K 7390-1:2015 standard.

(1) Production by Production Method (X1) (Examples 1-8 and 15-17 and Comparative Examples 1-3)

(First Step)

(Step X1-1)

A reaction vessel, including a stirrer, a nitrogen gas inlet, a thermometer, a rectification column, and a cooling condenser and having a capacity of 1000 mL, was provided. Into this reaction vessel, introduced were the recycled polyester, the polycarboxylic acid component, the polyalcohol component, and potassium titanium oxalate (as a catalyst) shown in Tables 1 and 2 to make a mixture. This mixture was heated to 200° C. while being stirred up and mixed in a nitrogen atmosphere under ordinary pressure, and then gradually heated to 250° C. for 6 hours, thereby causing an ester formation reaction and a depolymerization reaction.

(Second Step)

(Step X1-2)

After the step X1-1 had been performed, the pressure was gradually reduced to 0.67 hPa (0.5 mmHg) at a temperature of 250° C. and this state was maintained for 2 hours, thereby causing a polycondensation reaction. In this manner, a water-based polyester resin was produced.

(2) Production by Production Method (X2) (Examples 9-14 and 18-20 and Comparative Example 4)

(First Step)

(Step X2-1)

A reaction vessel, including a stirrer, a nitrogen gas inlet, a thermometer, a rectification column, and a cooling condenser and having a capacity of 1000 mL, was provided. Into this reaction vessel, introduced were the polycarboxylic acid component, the polyalcohol component, and potassium titanium oxalate (as a catalyst) shown in Tables 1 and 2 to make a mixture. This mixture was heated to 200° C. while being stirred up and mixed in a nitrogen atmosphere under ordinary pressure, and then gradually heated to 240° C. for 3 hours, thereby causing an ester formation reaction.

(Step X2-2)

After the step X2-1 had been performed, the recycled polyester shown in Tables 1 and 2 was introduced into the reaction vessel and heated to 250° C. while being stirred up and mixed in a nitrogen atmosphere under normal pressure and this state was maintained for 3 hours, thereby causing a depolymerization reaction.

(Second Step)

(Step X2-3)

After the step X2-2 had been performed, the pressure was gradually reduced to 0.67 hPa (0.5 mmHg) at a temperature of 250° C. and this state was maintained for 2 hours, thereby causing a polycondensation reaction. In this manner, a water-based polyester resin was produced.

(3) Reference Examples (Reference Examples 1-4)

The water-based polyester resins representing Examples 5, 9, and 13 and Comparative Example 1 were produced using either unused terephthalic acid or dimethyl terephthalate as an unused terephthalic acid derivative without using a recycled polyester. In this manner, water-based polyester resins were produced as Reference Examples 1-4.

<Preparation of Water-Based Coating Composition>

### (1) Examples 9, 11-13, and 18-20 and Comparative Example 2

A water-based coating composition having a resin concentration of 25% by mass was prepared by mixing 100 parts by mass of the water-based polyester resin produced as described above and 300 parts by mass of water and maintaining the mixture at a temperature of 90° C. for 2 hours while stirring up the mixture.

### (2) Examples 1-8, 10, and 14-17 and Comparative Examples 1, 3, and 4

The water-based polyester resin thus prepared had so low water solubility that the polyester resin could not be dispersed under the condition described in the item (1). Therefore, the water-based polyester resin was dispersed using n-butyl cellosolve as a hydrophilic organic solvent. Specifically, a water-based coating composition having a resin concentration of 25% by mass was prepared by mixing 100 parts by mass of the water-based polyester resin prepared as described above, 40 parts by mass of the n-butyl cellosolve, and 260 parts by mass of water and maintaining the mixture at a temperature of 90° C. for 2 hours while stirring up the mixture.

(3) Reference Examples (Reference Examples 1-4)

Water-based coating compositions, each having a resin concentration of 25% by mass, were prepared by applying the method as described in the item (2) to the water-based polyester resins obtained as Reference Examples 1 and 4 and by applying the method as described in the item (1) to the water-based polyester resins obtained as Reference Examples 2 and 3.

<Evaluation>

[Resin's Physical Properties]

The physical properties of each of the water-based polyester resins produced as described above were evaluated by the following methods.

(Acid Value (mgKOH/g))

The acid value of the water-based polyester resin was determined based on the results of measurement by titration using an ethanol solution of potassium hydroxide.

(Weight Average Molecular Weight)

The weight average molecular weight of the water-based polyester resin was determined based on the results of measurement by gel permeation chromatography (and was converted into a polystyrene equivalent molecular weight).

(Glass Transition Temperature)(° C.)

The glass transition temperature of the water-based polyester resin was determined based on the results of measurement by differential scanning calorimetry.

[Measurement of Physical Properties]

Each of the water-based coating compositions (resin dispersion liquids) prepared as described above had its physical properties measured by the following methods:

(Water Dispersibility)

The resin dispersion liquid was observed and graded as follows from its appearance:

Grade A: if no precipitates were recognized in the resin dispersion liquid;

Grade B: if a very small amount of precipitates was recognized in the resin dispersion liquid;

Grade C: if a lot of precipitates was recognized in the resin dispersion liquid; or

Grade D: if the resin was not dispersed in the solvent.

(Stability of Resin Dispersion Liquid)

The resin dispersion liquid was put into, and hermetically sealed in, a glass bottle, and allowed to stand still at 20° C. for 15 days. After that, the dispersion liquid was observed and graded as follows from its appearance:

Grade A: if no isolation or precipitate was recognized in the dispersion liquid;

Grade B: if isolation and/or precipitate was recognized a little in the dispersion liquid; or

Grade C: if a lot of isolation and/or precipitate was recognized in the dispersion liquid.

(Aging Stability in Solution Haze)

The resin dispersion liquid was put into, and hermetically sealed in, a glass bottle, and allowed to stand still at 5° C., 20° C., and 40° C. for 15 days. After that, the haze (%) of the dispersion liquid was measured using a haze meter manufactured by Nippon Denshoku Industries Co., Ltd. The dispersion liquid was graded as follows based on the results of the measurement:

Grade A: if the variation in the haze of the dispersion liquid was less than 20% compared to the haze of the dispersion liquid that had not been allowed to stand still yet;

Grade B: if the variation in the haze of the dispersion liquid was equal to or greater than 20% and or less than 40% compared to the haze of the dispersion liquid that had not been allowed to stand still yet;

Grade C: if the variation in the haze of the dispersion liquid was equal to or greater than 40% and or less than 60% compared to the haze of the dispersion liquid that had not been allowed to stand still yet; or

Grade D: if the variation in the haze of the dispersion liquid was equal to or greater than 60% compared to the haze of the dispersion liquid that had not been allowed to stand still yet or if the haze of the dispersion liquid was equal to or greater than 90%.

(Adhesion of PET Film)

An untreated biaxially oriented polyethylene terephthalate (PET) film was provided as a base member. The resin dispersion liquid was applied onto this base member using a bar coater, and then heated at 120° C. for 5 minutes. In this manner, a primer layer having a thickness of about 1 μm was formed on the base member. Subsequently, a cellophane adhesive tape was brought into close contact with the primer layer on the base member and then peeled off, and the remaining primer layer was observed. The primer layer was graded as follows from its appearance:

Grade A: if no peeling of the primer layer was recognized;

Grade B: if peeling was recognized in some parts of the primer layer; or

Grade C: if peeling was recognized in most of the primer layer.

(Adhesion of Aluminum Evaporated Layer)

An untreated biaxially oriented polyethylene terephthalate (PET) film was provided as a base member, and a primer layer was formed to a thickness of about 1 μm on the base member by the same method as the one described for the “adhesion of PET film” section. Subsequently, an aluminum evaporated layer was formed by vacuum deposition process to a thickness of about 1 μm on the primer layer on the base member. A cellophane adhesive tape was brought into close contact with the aluminum evaporated layer and then peeled off, and the remaining aluminum evaporated layer was observed. The aluminum evaporated layer was graded as follows from its appearance;

Grade A: if no peeling of the aluminum evaporated layer was recognized;

Grade B: if peeling was recognized in some parts of the aluminum evaporated layer; or

Grade C: if peeling was recognized in most of the aluminum evaporated layer.

(Haze)

An untreated biaxially oriented polyethylene terephthalate (PET) film was provided as a base member. The resin dispersion liquid was applied onto this base member using a bar coater, and then heated at 120° C. for 5 minutes. In this manner, a primer layer having a thickness of about 3 μm was formed on the base member. Subsequently, the haze of the base member alone and the haze of the base member and the primer layer combined were measured using a haze meter manufactured by Nippon Denshoku Industries Co., Ltd. The haze (%) of the primer layer was calculated by subtracting the haze of the base member alone from the haze of the base member and the primer layer combined.

The following Tables 1 and 2 summarize the evaluation results of physical property tests on the water dispersibility, the stability of the resin dispersion liquid, the adhesion of the PET film, the adhesion of aluminum evaporated layer, and the haze. Note that “-” in the evaluation result for Comparative Example 3 indicates that the sample was graded D in terms of water dispersibility (i.e., the resin was not dispersed in the solvent), and therefore, subjected to no other evaluation tests.

TABLE 1

| | | | Examples | | | | | | | | | | | | | |
|---|---|---|---|---|---|---|---|---|---|---|---|---|---|---|---|---|
| Amount used | | | 1 | | 2 | | 4 | | 5 | | 6 | | | 7 | | |
| Reaction | Polycarboxylic | Sodium dimethyl 5-sulfoisophthalate | 30 | g | 50 | g | 35 | g | 35 | g | 35 | g | | 35 | | g |
| materials | acid components | | 0.101 | mol | 0.169 | mol | 0.118 | mol | 0.118 | mol | 0.118 | mol | | 0.118 | | mol |
| | | | 7.2 | wt % | 11.0 | wt % | 7.7 | wt % | 7.7 | wt % | 7.7 | wt % | | 7.7 | | wt % |
| | | Isophthalic acid | 60 | g | 60 | g | 40 | g | 75 | g | 75 | g | | 75 | | g |
| | | | 0.361 | mol | 0.361 | mol | 0.241 | mol | 0.451 | mol | 0.451 | mol | | 0.451 | | mol |
| | | | 14.5 | wt % | 13.2 | wt % | 8.8 | wt % | 16.5 | wt % | 16.5 | wt % | | 16.5 | | wt % |
| | | Dimethyl 2,6-naphthalene dicarboxylate | | | | | | | | | | | | | | |
| | | Sebacic acid | | | | | 35 | g | | | | | | | | |
| | | | | | | | 0.173 | mol | | | | | | | | |
| | | | | | | | 7.7 | wt % | | | | | | | | |
| | | Trimellitic anhydride | | | | | | | | | | | | | | |
| | | Dimethyl terephthalate | | | | | | | | | | | | | | |
| | Polyalcohol | Ethylene glycol | 45 | g | 49 | g | 50 | g | 94 | g | 92 | g | | 90 | | g |
| | components | | 0.725 | mol | 0.790 | mol | 0.806 | mol | 1.515 | mol | 1.482 | mol | | 1.450 | | mol |
| | | | 10.8 | wt % | 10.8 | wt % | 11.0 | wt % | 20.7 | wt % | 20.3 | wt % | | 19.8 | | wt % |
| | | Diethylene glycol | | | | | | | | | | | | | | |
| | | Neopentyl glycol | | | | | | | | | | | | | | |
| | | 1,2-propane diol | | | | | | | | | | | | | | |
| | | 1,3-butane diol | | | | | | | | | | | | | | |
| | | 1,3-propane diol | 30 | g | 45 | g | 44 | g | | | | | | | | |
| | | | 0.394 | mol | 0.591 | mol | 0.578 | mol | | | | | | | | |
| | | | 7.2 | wt % | 9.9 | wt % | 9.7 | wt % | | | | | | | | |
| | | Trimethylolpropane | | | | | | | | | 2 | g | | 4 | | g |
| | | | | | | | | | | | 0.015 | mol | | 0.030 | | mol |
| | | | | | | | | | | | 0.4 | wt % | | 0.9 | | wt % |
| | Recycled | Recycled PET-A | 250 | g | 250 | g | | | | | | | | | | |
| | polyester | | 60.2 | wt % | 55.1 | wt % | | | | | | | | | | |
| | | Recycled PET-B | | | | | 250 | g | 250 | g | 250 | g | | 250 | | g |
| | | | | | | | 55.1 | wt % | 55.1 | wt % | 55.1 | wt % | | 55.1 | | wt % |
| | | Recycled PET-C | | | | | | | | | | | | | | |
| | | Recycled PET-D | | | | | | | | | | | | | | |
| Catalyst | | Potassium titanium oxalate | 0.05 | g | 0.05 | g | 0.05 | g | 0.05 | g | 0.05 | g | | 0.05 | | g |
| Total amount of compound | | | 415.05 | g | 454.05 | g | 454.05 | g | 454.05 | g | 454.05 | g | | 454.05 | | g |
| Polyalcohol component/polycarboxylic acid component (molar ratio) | | | 2.4/1 | | 2.6/1 | | 2.6/1 | | 2.7/1 | | 2.6/1 | | | 2.6/1 | | |
| Terephthalic acid residue (mass %) derived from recycled polyester | | | 70.6 | | 66.3 | | 66.0 | | 66.3 | | 66.3 | | | 66.3 | | |
| Metal-sulfonate-group-containing polycarboxylic acid residue (mass %) | | | 9.7 | | 15.3 | | 10.6 | | 10.7 | | 10.7 | | | 10.7 | | |
| Additional polycarboxylic acid residue (mass %) | | | 19.6 | | 18.4 | | 23.4 | | 23.0 | | 23.0 | | | 23.0 | | |
| Terephthalic acid residue (mass %) not derived from recycled polyester | | | 0 | | 0 | | 0 | | 0 | | 0 | | | 0 | | |
| Resin | Weight average molecular weight | | 21500 | | 16800 | | 23400 | | 18200 | | 20300 | | | 22400 | | |
| Physical | Glass transition temperature (° C.) | | 52 | | 48 | | 28 | | 58 | | 57 | | | 58 | | |
| Properties | Acid value (mgKOH/g) | | 2 | | 5 | | 3 | | 2 | | 6 | | | 5 | | |
| Physical | Water dispersibility | | A | | A | | A | | A | | A | | | B | | |
| Property | Stability of resin dispersion liquid | | B | | A | | A | | A | | A | | | B | | |
| Tests | Aging stability in solution haze (variation in haze of dispersion liquid at 5° C.) | | A | | A | | A | | A | | A | | | A | | |
| | Aging stability in solution haze (variation in haze of dispersion liquid at 20° C.) | | B | | A | | A | | A | | A | | | B | | |
| | Aging stability in solution haze (variation in haze of dispersion liquid at 40° C.) | | C | | B | | B | | B | | B | | | C | | |
| | Adhesion of PET film | | A | | A | | A | | A | | A | | | B | | |
| | Adhesion of aluminum evaporated layer | | A | | A | | A | | A | | A | | | B | | |
| | Haze (%) | | 0.0 | | 0.0 | | 0.0 | | 0.0 | | 0.0 | | | 0.2 | | |
| | | | Examples | | | | | | | | | | | | | |
| Amount used | | | 8 | | 9 | | 10 | | 11 | | 12 | | 13 | | 14 | |
| Reaction | Polycarboxylic | Sodium dimethyl 5-sulfoisophthalate | 35 | g | 80 | g | 40 | g | 70 | g | 80 | g | 140 | g | 30 | g |
| materials | acid components | | 0.118 | mol | 0.270 | mol | 0.135 | mol | 0.236 | mol | 0.270 | mol | 0.473 | mol | 0.101 | mol |
| | | | 7.7 | wt % | 16.0 | wt % | 8.0 | wt % | 14.0 | wt % | 16.0 | wt % | 22.4 | wt % | 4.8 | wt % |
| | | Isophthalic acid | 73 | g | | | | | 60 | g | 57 | g | 100 | g | 170 | g |
| | | | 0.439 | mol | | | | | 0.361 | mol | 0.343 | mol | 0.602 | mol | 1.023 | mol |
| | | | 16.1 | wt % | | | | | 12.0 | wt % | 11.4 | wt % | 16.0 | wt % | 27.2 | wt % |
| | | Dimethyl 2,6-naphthalene dicarboxylate | | | 50 | g | 90 | g | | | | | | | | |
| | | | | | 0.205 | mol | 0.368 | mol | | | | | | | | |
| | | | | | 10.0 | wt % | 18.0 | wt % | | | | | | | | |
| | | Sebacic acid | | | | | | | | | | | | | | |
| | | Trimellitic anhydride | 2 | g | | | | | | | | | | | | |
| | | | 0.010 | mol | | | | | | | | | | | | |
| | | | 0.4 | wt % | | | | | | | | | | | | |
| | | Dimethyl terephthalate | | | | | | | | | | | | | | |
| | Polyalcohol | Ethylene glycol | 94 | g | 120 | g | 120 | g | 80 | g | 113 | g | 135 | g | 125 | g |
| | components | | 1.515 | mol | 1.934 | mol | 1.934 | mol | 1.289 | mol | 1.821 | mol | 2.175 | mol | 2.014 | mol |
| | | | 20.7 | wt % | 24.0 | wt % | 24.0 | wt % | 16.0 | wt % | 22.6 | wt % | 21.6 | wt % | 20.0 | wt % |
| | | Diethylene glycol | | | | | | | 40 | g | | | | | 50 | g |
| | | | | | | | | | 0.377 | mol | | | | | 0.471 | mol |
| | | | | | | | | | 8.0 | wt % | | | | | 8.0 | wt % |
| | | Neopentyl glycol | | | | | | | | | | | | | | |
| | | 1,2-propane diol | | | | | | | | | | | | | | |
| | | 1,3-butane diol | | | | | | | | | | | | | | |
| | | 1,3-propane diol | | | | | | | | | | | | | | |
| | | Trimethylolpropane | | | | | | | | | | | | | | |
| | Recycled | Recycled PET-A | | | | | | | | | | | | | | |
| | polyester | Recycled PET-B | 250 | g | | | | | | | | | | | | |
| | | | 55.1 | wt % | | | | | | | | | | | | |
| | | Recycled PET-C | | | 250 | g | 250 | g | 250 | g | | | | | | |
| | | | | | 50.0 | wt % | 50.0 | wt % | 50.0 | wt % | | | | | | |
| | | Recycled PET-D | | | | | | | | | 250 | g | 250 | g | 250 | g |
| | | | | | | | | | | | 50.0 | wt % | 40.0 | wt % | 40.0 | wt % |

| | | | | | | | | | | | | | | | |
|---|---|---|---|---|---|---|---|---|---|---|---|---|---|---|---|
| Catalyst | Potassium titanium oxalate | 0.05 | g | 0.05 | g | 0.05 | g | 0.05 | g | 0.05 | g | 0.05 | g | 0.05 | g |

| | | | | | | | | | | | | | | |
|---|---|---|---|---|---|---|---|---|---|---|---|---|---|---|
| Total amount of compound | 454.05 | g | 500.05 | g | 500.05 | g | 500.05 | g | 500.05 | g | 625.05 | g | 625.05 | g |

| Polyalcohol component/polycarboxylic acid component (molar ratio) | | 2.7/1 | 4.1/1 | 3.8/1 | 2.8/1 | 3.0/1 | 2.0/1 | 2.2/1 |
|---|---|---|---|---|---|---|---|---|
| Terephthalic acid residue (mass %) derived from recycled polyester | | 66.3 | 63.1 | 63.5 | 62.5 | 61.3 | 47.5 | 52.0 |
| Metal-sulfonate-group-containing polycarboxylic acid residue (mass %) | | 10.7 | 23.2 | 11.7 | 20.1 | 22.5 | 30.6 | 7.2 |
| Additional polycarboxylic acid residue (mass %) | | 23.1 | 13.7 | 24.8 | 17.4 | 16.2 | 22.0 | 40.9 |
| Terephthalic acid residue (mass %) not derived from recycled polyester | | 0 | 0 | 0 | 0 | 0 | 0 | 0 |
| Resin | Weight average molecular weight | 21600 | 14800 | 19200 | 15500 | 18900 | 15600 | 21500 |
| Physical | Glass transition temperature (° C.) | 59 | 67 | 72 | 56 | 58 | 64 | 46 |
| Properties | Acid value (mgKOH/g) | 6 | 3 | 2 | 4 | 2 | 5 | 3 |
| Physical | Water dispersibility | B | A | A | A | A | A | A |
| Property | Stability of resin dispersion liquid | B | A | A | A | A | A | A |
| Tests | Aging stability in solution haze (variation in haze of dispersion | A | A | A | A | A | A | A |
| | liquid at 5° C.) | | | | | | | |
| | Aging stability in solution haze (variation in haze of dispersion | B | A | A | A | A | A | A |
| | liquid at 20° C.) | | | | | | | |
| | Aging stability in solution haze (variation in haze of dispersion | C | B | B | B | B | B | B |
| | liquid at 40° C.) | | | | | | | |
| | Adhesion of PET film | B | A | B | A | A | A | A |
| | Adhesion of aluminum evaporated layer | B | A | B | A | A | A | A |
| | Haze (%) | 0.3 | 0.0 | 0.0 | 0.0 | 0.0 | 0.0 | 0.0 |

TABLE 2

| | | | Examples | | | | | | | | | | | | | | | |
|---|---|---|---|---|---|---|---|---|---|---|---|---|---|---|---|---|---|---|
| Amount used | | | 3 | | 15 | | 16 | | 17 | | 18 | | 19 | | | 20 | | |
| Reaction | Polycarboxylic | Sodium dimethyl 5-sulfoisophthalate | 50 | g | 30 | g | 50 | g | 35 | g | 70 | g | 80 | g | | 80 | | g |
| materials | acid components | | 0.169 | mol | 0.101 | mol | 0.169 | mol | 0.118 | mol | 0.236 | mol | 0.270 | mol | | 0.270 | | mol |
| | | | 11.0 | wt % | 7.2 | wt % | 11.0 | wt % | 7.7 | wt % | 14.0 | wt % | 16.0 | wt % | | 16.0 | | wt % |
| | | Isophthalic acid | 60 | g | 60 | g | 60 | g | 40 | g | 60 | g | 57 | g | | 57 | | g |
| | | | 0.361 | mol | 0.361 | mol | 0.361 | mol | 0.241 | mol | 0.361 | mol | 0.343 | mol | | 0.343 | | mol |
| | | | 13.2 | wt % | 14.5 | wt % | 13.2 | wt % | 8.8 | wt % | 12.0 | wt % | 11.4 | wt % | | 11.4 | | wt % |
| | | Dimethyl 2,6-naphthalene dicarboxylate | | | | | | | | | | | | | | | | |
| | | Sebacic acid | | | | | | | 35 | g | | | | | | | | |
| | | | | | | | | | 0.173 | mol | | | | | | | | |
| | | | | | | | | | 7.7 | wt % | | | | | | | | |
| | | Trimellitic anhydride | | | | | | | | | | | | | | | | |
| | | Dimethyl terephthalate | | | | | | | | | | | | | | | | |
| | Polyalcohol | Ethylene glycol | 49 | g | 45 | g | 59 | g | 55 | g | 90 | g | 90 | g | | 83 | | g |
| | components | | 0.790 | mol | 0.725 | mol | 0.951 | mol | 0.886 | mol | 1.450 | mol | 1.450 | mol | | 1.337 | | mol |
| | | | 10.8 | wt % | 10.8 | wt % | 13.0 | wt % | 12.1 | wt % | 18.0 | wt % | 18.0 | wt % | | 16.6 | | wt % |
| | | Diethylene glycol | | | | | 15 | g | | | 15 | g | | | | | | |
| | | | | | | | 0.141 | mol | | | 0.141 | mol | | | | | | |
| | | | | | | | 3.3 | wt % | | | 3.0 | wt % | | | | | | |
| | | Neopentyl glycol | 45 | g | 30 | g | | | 39 | g | 15 | g | 23g | | | | | |
| | | | 0.432 | mol | 0.288 | mol | | | 0.374 | mol | 0.144 | mol | 0.221 | mol | | | | |
| | | | 9.9 | wt % | 7.2 | wt % | | | 8.6 | wt % | 3.0 | wt % | 4.6 | wt % | | | | |
| | | 1,2-propane diol | | | | | 20 | g | | | | | | | | | | |
| | | | | | | | 0.263 | mol | | | | | | | | | | |
| | | | | | | | 4.4 | wt % | | | | | | | | | | |
| | | 1,3-butane diol | | | | | | | | | | | | | | 30 | | g |
| | | | | | | | | | | | | | | | | 0.333 | | mol |
| | | | | | | | | | | | | | | | | 6.0 | | wt % |
| | | 1,3-propane diol | | | | | | | | | | | | | | | | |
| | | Trimethylolpropane | | | | | | | | | | | | | | | | |
| | | Recycled PET-A | 250 | g | 250 | g | 250 | g | | | | | | | | | | |
| | | | 55.1 | wt % | 60.2 | wt % | 55.1 | wt % | | | | | | | | | | |
| | | Recycled PET-B | | | | | | | 250 | g | | | | | | | | |
| | Recycled | | | | | | | | 55.1 | wt % | | | | | | | | |
| | polyester | Recycled PET-C | | | | | | | | | 250 | g | | | | | | |
| | | | | | | | | | | | 50.0 | wt % | | | | | | |
| | | Recycled PET-D | | | | | | | | | | | 250 | g | | 250 | | g |
| | | | | | | | | | | | | | 50.0 | wt % | | 50.0 | | wt % |
| Catalyst | | Potassium titanium oxalate | 0.05 | g | 0.05 | g | 0.05 | g | 0.05 | g | 0.05 | g | 0.05 | g | | 0.05 | | g |
| Total amount of compound | | | 454.05 | g | 415.05 | g | 454.05 | g | 454.05 | g | 500.05 | g | 500.05 | g | | 500.05 | | g |
| Polyalcohol component/polycarboxylic acid component (molar ratio) | | | 2.3/1 | | 2.2/1 | | 2.6/1 | | 2.4/1 | | 2.9/1 | | 2.7/1 | | | 2.7/1 | | |
| Terephthalic acid residue (mass %) derived from recycled polyester | | | 66.3 | | 70.6 | | 66.3 | | 66.0 | | 62.5 | | 61.3 | | | 61.3 | | |
| Metal-sulfonate-group-containing polycarboxylic acid residue (mass %) | | | 15.3 | | 9.7 | | 15.3 | | 10.6 | | 20.1 | | 22.5 | | | 22.5 | | |
| Additional polycarboxylic acid residue (mass %) | | | 18.4 | | 19.6 | | 18.4 | | 23.4 | | 17.4 | | 16.2 | | | 16.2 | | |
| Terephthalic acid residue (mass %) not derived from recycled polyester | | | 0 | | 0 | | 0 | | 0 | | 0 | | 0 | | | 0 | | |
| Resin | Weight average molecular weight | | 18200 | | 22300 | | 19200 | | 22300 | | 16400 | | 18900 | | | 19300 | | |
| Physical | Glass transition temperature (° C.) | | 62 | | 59 | | 50 | | 40 | | 54 | | 58 | | | 51 | | |
| Properties | Acid value (mgKOH/g) | | 5 | | 2 | | 4 | | 2 | | 3 | | 2 | | | 2 | | |
| Physical | Water dispersibility | | A | | A | | A | | A | | A | | A | | | A | | |
| Property | Stability of resin dispersion liquid | | A | | A | | A | | A | | A | | A | | | A | | |
| Tests | Aging stability in solution haze (variation in haze of dispersion | | A | | A | | A | | A | | A | | A | | | A | | |
| | liquid at 5° C.) | | | | | | | | | | | | | | | | | |
| | Aging stability in solution haze (variation in haze of dispersion | | A | | A | | A | | A | | A | | A | | | A | | |
| | liquid at 20° C.) | | | | | | | | | | | | | | | | | |
| | Aging stability in solution haze (variation in haze of dispersion | | A | | A | | A | | A | | A | | A | | | A | | |
| | liquid at 40° C.) | | | | | | | | | | | | | | | | | |
| | Adhesion of PET film | | A | | A | | A | | A | | A | | A | | | A | | |
| | Adhesion of aluminum evaporated layer | | A | | A | | A | | A | | A | | A | | | A | | |
| | Haze (%) | | 0.0 | | 0.0 | | 0.0 | | 0.0 | | 0.0 | | 0.0 | | | 0.0 | | |
| | | | Comparative examples | | | | | | | | Reference examples | | | | | | | |
| Amount used | | | 1 | | 2 | | 3 | | 4 | | 1 | | 2 | | 3 | | 4 | |
| Reaction | Polycarboxylic | Sodium dimethyl | 36 | g | 83 | g | | | 50 | g | 35 | g | 80 | g | 140 | g | 36 | g |
| materials | acid components | 5-sulfoisophthalate | 0.122 | mol | 0.280 | mol | | | 0.169 | mol | 0.118 | mol | 0.270 | mol | 0.473 | mol | 0.122 | mol |
| | | | 9.0 | wt % | 20.0 | wt % | | | 10.0 | wt % | 6.2 | wt % | 14.0 | wt % | 18.5 | wt % | 7.2 | wt % |
| | | Isophthalic acid | 24 | g | | | 110 | g | 120 | g | 75 | g | | | 100 | g | 24 | g |
| | | | 0.144 | mol | | | 0.662 | mol | 0.722 | mol | 0.451 | mol | | | 0.602 | mol | 0.144 | mol |
| | | | 6.0 | wt % | | | 24.2 | wt % | 24.0 | wt % | 13.3 | wt % | | | 13.2 | wt % | 4.8 | wt % |
| | | Dimethyl 2,6-naphthalene | | | | | | | | | | | 50 | g | | | | |
| | | dicarboxylate | | | | | | | | | | | 0.205 | mol | | | | |
| | | | | | | | | | | | | | 8.7 | wt % | | | | |
| | | Sebacic acid | | | | | | | | | | | | | | | | |
| | | Trimellitic anhydride | | | | | | | | | | | | | | | | |
| | | Dimethyl terephthalate | | | | | | | | | 234 | g | 234 | g | 234 | g | 268 | g |
| | | | | | | | | | | | 1.205 | mol | 1.205 | mol | 1.205 | mol | 1.380 | mol |
| | | | | | | | | | | | 41.5 | wt % | 40.8 | wt % | 30.9 | wt % | 53.7 | wt % |
| | Polyalcohol | Ethylene glycol | 40 | g | 83 | g | 94 | g | 40 | g | 220 | g | 209 | g | 283 | g | 171 | g |
| | components | | 0.645 | mol | 1.337 | mol | 1.515 | mol | 0.645 | mol | 3.54 | mol | 3.37 | mol | 4.56 | mol | 2.76 | mol |
| | | | 10.0 | wt % | 20.0 | wt % | 20.7 | wt % | 8.0 | wt % | 39.0 | wt % | 36.5 | wt % | 37.4 | wt % | 34.3 | wt % |
| | | Diethylene glycol | | | | | | | | | | | | | | | | |
| | | Neopentyl glycol | | | | | | | 40 | g | | | | | | | | |
| | | | | | | | | | 0.384 | mol | | | | | | | | |
| | | | | | | | | | 8.0 | wt % | | | | | | | | |
| | | 1,2-propane diol | | | | | | | | | | | | | | | | |
| | | 1,3-butane diol | | | | | | | | | | | | | | | | |
| | | 1,3-propane diol | | | | | | | | | | | | | | | | |
| | | Trimethylolpropane | | | | | | | | | | | | | | | | |
| | Recycled | Recycled PET-A | 300 | g | 249 | g | | | | | | | | | | | | |
| | polyester | | 75.0 | wt % | 60.0 | wt % | | | | | | | | | | | | |
| | | Recycled PET-B | | | | | 250 | g | | | | | | | | | | |
| | | | | | | | 55.1 | wt % | | | | | | | | | | |
| | | Recycled PET-C | | | | | | | 250 | g | | | | | | | | |
| | | | | | | | | | 50.0 | wt % | | | | | | | | |
| | | Recycled PET-D | | | | | | | | | | | | | | | | |

| | | | | | | | | | | | | | | | | | |
|---|---|---|---|---|---|---|---|---|---|---|---|---|---|---|---|---|---|
| Catalyst | Potassium titanium oxalate | 0.05 | g | 0.05 | g | 0.05 | g | 0.05 | g | 0.10 | g | 0.10 | g | 0.10 | g | 0.10 | g |

| | | | | | | | | | | | | | | | | |
|---|---|---|---|---|---|---|---|---|---|---|---|---|---|---|---|---|
| Total amount of compound | 400.05 | g | 415.05 | g | 454.05 | g | 500.05 | g | 564.10 | g | 573.10 | g | 757.10 | g | 499.10 | g |

| Polyalcohol component/polycarboxylic acid component (molar | | 2.4/1 | 4.8/1 | 2.3/1 | 1.2/1 | 2.0/1 | 2.0/1 | 2.0/1 | 2.0/1 |
|---|---|---|---|---|---|---|---|---|---|
| ratio) | | | | | | | | | |
| Terephthalic acid residue (mass %) derived from recycled polyester | | 81.3 | 72.3 | 66.3 | 56.0 | 0 | 0 | 0 | 0 |
| Metal-sulfonate-group-containing polycarboxylic acid residue | | 11.2 | 27.7 | 0.0 | 12.9 | 10.7 | 23.2 | 30.6 | 11.2 |
| (mass %) | | | | | | | | | |
| Additional polycarboxylic acid residue (mass %) | | 7.5 | 0.0 | 33.7 | 31.1 | 23.0 | 13.7 | 22.0 | 7.5 |
| Terephthalic acid residue (mass %) not derived from recycled | | 0 | 0 | 0 | 0 | 66.3 | 63.1 | 47.5 | 81.2 |
| polyester | | | | | | | | | |
| Resin | Weight average molecular weight | 26900 | 13100 | 25800 | 10400 | 17100 | 15900 | 16300 | 29800 |
| Physical | Glass transition temperature (° C.) | 65 | 62 | 60 | 64 | 60 | 65 | 65 | 68 |
| Properties | Acid value (mgKOH/g) | 5 | 5 | 2 | 14 | 3 | 3 | 4 | 2 |
| Physical | Water dispersibility | C | B | D | C | A | A | A | A |
| Property | Stability of resin dispersion liquid | C | C | — | C | A | A | A | B |
| Tests | Aging stability in solution haze (variation in haze of | C | C | — | C | A | A | A | A |
| | dispersion liquid at 5° C.) | | | | | | | | |
| | Aging stability in solution haze (variation in haze of | D | D | — | D | A | A | A | C |
| | dispersion liquid at 20° C.) | | | | | | | | |
| | Aging stability in solution haze (variation in haze of | D | D | — | D | B | B | B | D |
| | dispersion liquid at 40° C.) | | | | | | | | |
| | Adhesion of PET film | C | B | — | C | A | A | A | A |
| | Adhesion of aluminum evaporated layer | C | B | — | C | A | A | A | A |
| | Haze (%) | 1.5 | 0.7 | — | 0.9 | 0.0 | 0.0 | 0.0 | 0.0 |

As can be seen from the results shown in these Tables 1 and 2, the water-based polyester resin according to each of Examples 1-20 exhibited not only excellent water dispersibility even in the absence of any surfactant, for example, but also good stability when used as a resin dispersion liquid while reducing the environmental load. In addition, as also can be seen from comparison with the water-based polyester resins representing Reference Examples 1-4, each of which was produced using unused terephthalic acid or dimethyl terephthalate as a terephthalic acid derivative, the water-based polyester resin according to each of Examples 1-20 included a residue of terephthalic acid derived from a recycled polyester and still exhibited as good resin properties (such as adhesion and transparency) as in a situation where terephthalic acid or a terephthalic acid derivative not derived from a recycled polyester was used, and the resin dispersion liquid thereof not only exhibited good water dispersibility for a long term but also further improved its stability such as aging stability in solution haze. Among other things, the water-based polyester resin according to each of Example 3 and Examples 15-20 achieved excellent aging stability (at 5° C., 20° C., and 40ºC) (i.e., graded A) in the solution haze of the resin dispersion liquid by using a dihydric alcohol compound having a branched chain at a particular proportion.

On the other hand, the water-based polyester resin produced by the production method according to Comparative Example 3 could not be dispersed in water or water containing a hydrophilic organic solvent without using a surfactant, for example. The water-based polyester resin produced by the production method according to any of Comparative Examples 1, 2, and 4 was inferior in the stability of the resin dispersion liquid.

Note that as for each of the water-based polyester resins representing Examples 2-6 and 9-20, which were graded A in the “stability of the resin dispersion liquid,” even after the resin dispersion liquid was put into, and hermetically sealed in, a glass bottle and allowed to stand still at 20ºC for 30 days, no isolation or precipitate was recognized in the appearance of the resin dispersion liquid.

(Recapitulation)

As can be seen from the foregoing description, a method for producing a water-based polyester resin according to a first aspect of the present disclosure is a method for producing a water-based polyester resin using a recycled polyester. The method includes a first step and a second step. The first step includes causing an ester formation reaction and a depolymerization reaction using the recycled polyester, a polycarboxylic acid component including a polycarboxylic acid residue and excluding terephthalic acid, and a polyalcohol component. The second step includes causing a polycondensation reaction by reducing pressure. The polycarboxylic acid component includes; at least one metal-sulfonate-group-containing polycarboxylic acid compound selected from the group consisting of polycarboxylic acids, each having a metal sulfonate group and including a metal-sulfonate-group-containing polycarboxylic acid residue, and esters and anhydrides thereof; and at least one additional polycarboxylic acid compound selected from the group consisting of polycarboxylic acids other than the terephthalic acid and the metal-sulfonate-group-containing polycarboxylic acid compound and esters and anhydrides thereof. The first step includes using: the recycled polyester to such an amount that makes proportion of the terephthalic acid residue with respect to a total of the terephthalic acid residue included in the recycled polyester and the polycarboxylic acid residue included in the polycarboxylic acid component equal to or greater than 20% by mass and equal to or less than 72% by mass; and the metal-sulfonate-group-containing polycarboxylic acid compound to such an amount that makes proportion of the metal-sulfonate-group-containing polycarboxylic acid residue with respect to a total of the terephthalic acid residue included in the recycled polyester and the polycarboxylic acid residue included in the polycarboxylic acid component equal to or greater than 5% by mass and equal to or less than 32% by mass. The water-based polyester resin thus produced has an acid value equal to or less than 10 mgKOH/g.

The first aspect enables producing a water-based polyester resin having the following advantageous features. Specifically, the water-based polyester resin exhibits not only excellent water dispersibility even in the absence of any surfactant, for example, but also good stability when used as a resin dispersion liquid while reducing the environmental load. In addition, the water-based polyester resin includes a residue of terephthalic acid derived from a recycled polyester and still has as good resin properties (such as adhesion and transparency) as in a situation where terephthalic acid or a terephthalic acid derivative not derived from a recycled polyester is used. Furthermore, the resin dispersion liquid of the water-based polyester resin not only exhibits good water dispersibility for a long term but also further improves its stability such as aging stability in solution haze.

In a method for producing a water-based polyester resin according to a second aspect, which may be implemented in conjunction with the first aspect, the first step includes causing the ester formation reaction and the depolymerization reaction after having compounded the recycled polyester, the polycarboxylic acid component, and the polyalcohol component with each other.

The second aspect enables producing a water-based polyester resin by a simpler method.

In a method for producing a water-based polyester resin according to a third aspect, which may be implemented in conjunction with the first aspect, the first step includes: causing the ester formation reaction after having compounded the polycarboxylic acid component and the polyalcohol component with each other; and causing the depolymerization reaction after having added the recycled polyester thereto.

The third aspect enables causing, for example, the depolymerization reaction of the recycled polyester more appropriately by separately conducting compounding and reaction in these three steps, thus further improving the water dispersibility of the water-based polyester resin and the stability of the resin dispersion liquid.

In a method for producing a water-based polyester resin according to a fourth aspect, which may be implemented in conjunction with any one of the first to third aspects, the first step includes further using the additional polycarboxylic acid compound to such an amount that makes proportion of an additional polycarboxylic acid residue with respect to the total of the terephthalic acid residue included in the recycled polyester and the polycarboxylic acid residue included in the polycarboxylic acid component equal to or greater than 5% by mass and equal to or less than 50% by mass.

The fourth aspect enables decreasing the degree of crystallinity of the water-based polyester resin more adequately and thereby further improving the water dispersibility and the stability of the resin dispersion liquid.

In a method for producing a water-based polyester resin according to a fifth aspect, which may be implemented in conjunction with any one of the first to fourth aspects, the polycarboxylic acid component used in the first step contains no trivalent or higher valent polycarboxylic acid compounds.

The fifth aspect enables further decreasing the acid value of the water-based polyester resin and also allows the water-based polyester resin to have an even smaller number of crosslinked structures formed due to the presence of the trivalent or higher valent polycarboxylic acid compound. Consequently, the water dispersibility of the water-based polyester resin and the stability of the resin dispersion liquid thereof are further improvable.

In a method for producing a water-based polyester resin according to a sixth aspect, which may be implemented in conjunction with any one of the first to fifth aspects, the polyalcohol component used in the first step either contains no trihydric or higher hydric polyalcohol compound or contains a trihydric or higher hydric polyalcohol compound. Proportion of the trihydric or higher hydric polyalcohol compound is equal to or less than 5% by mass with respect to the entire polyalcohol component used.

The sixth aspect allows the water-based polyester resin to have an even smaller number of crosslinked structures formed due to the presence of the trihydric or higher hydric polyalcohol compound. Consequently, the water dispersibility and the stability of the resin dispersion liquid thereof are further improvable.

In a method for producing a water-based polyester resin according to a seventh aspect, which may be implemented in conjunction with any one of the first to sixth aspects, the polyalcohol component used in the first step includes a dihydric alcohol compound. The dihydric alcohol compound has a branched chain. Proportion of the dihydric alcohol compound having the branched chain is equal to or greater than 5% by mass and equal to or less than 50% by mass with respect to the entire polyalcohol component used.

The seventh aspect allows the resin dispersion liquid of the water-based polyester resin to further improve its stability such as aging stability in solution haze.

A water-based polyester resin according to an eighth aspect is produced by the method for producing a water-based polyester resin according to any one of the first to seventh aspects.

The eighth aspect enables producing a water-based polyester resin having the above-described advantageous features.

A water-based polyester resin according to a ninth aspect contains; a terephthalic acid residue derived from a recycled polyester; and a polycarboxylic acid residue other than the terephthalic acid residue. The polycarboxylic acid residue includes; a metal-sulfonate-group-containing polycarboxylic acid residue; and an additional polycarboxylic acid residue other than the terephthalic acid residue and the metal-sulfonate-group-containing polycarboxylic acid residue. Proportion of the terephthalic acid residue with respect to the entire polycarboxylic acid residue included in the water-based polyester resin is equal to or greater than 20% by mass and equal to or less than 72% by mass. Proportion of the metal-sulfonate-group-containing polycarboxylic acid residue with respect to the entire polycarboxylic acid residue included in the water-based polyester resin is equal to or greater than 5% by mass and equal to or less than 32% by mass. The water-based polyester resin has an acid value equal to or less than 10 mgKOH/g.

The ninth aspect allows the water-based polyester resin to have the following advantageous features. Specifically, the water-based polyester resin exhibits not only excellent water dispersibility even in the absence of a surfactant, for example, but also good stability when used as a resin dispersion liquid, while reducing the environmental load. In addition, the water-based polyester resin includes a terephthalic acid residue derived from a recycled polyester but still has as good resin properties (such as adhesion and transparency) as in a situation where terephthalic acid or a terephthalic acid derivative not derived from a recycled polyester is used. Furthermore, a resin dispersion liquid of the water-based polyester resin not only exhibits good water dispersibility for a long term but also further improves stability such as aging stability in solution haze.

In a water-based polyester resin according to a tenth aspect, which may be implemented in conjunction with the ninth aspect, proportion of the additional polycarboxylic acid residue with respect to the entire polycarboxylic acid residue included in the water-based polyester resin is equal to or greater than 5% by mass and equal to or less than 50% by mass.

The tenth aspect allows the water-based polyester resin to have its degree of crystallinity decreased more adequately and thereby further improve the water dispersibility and the stability of the resin dispersion liquid thereof.

In a water-based polyester resin according to an eleventh aspect, which may be implemented in conjunction with the ninth or tenth aspect, the polycarboxylic acid residue includes no trivalent or higher valent polycarboxylic acid compound residues.

The eleventh aspect allows the water-based polyester resin to have its acid value further decreased and to have an even smaller number of crosslinked structures formed due to the presence of the trivalent or higher valent polycarboxylic acid compound. Consequently, the water dispersibility of the water-based polyester resin and the stability of the resin dispersion liquid thereof are further improvable.

A water-based polyester resin according to a twelfth aspect, which may be implemented in conjunction with any one of the ninth to eleventh aspects, further contains a polyalcohol residue. The polyalcohol residue either contains no trihydric or higher hydric polyalcohol compound residue or contains a trihydric or higher hydric polyalcohol compound residue. Proportion of the trihydric or higher hydric polyalcohol compound residue is equal to or less than 5% by mass with respect to the entire polyalcohol residue included in the water-based polyester resin.

The twelfth aspect allows the water-based polyester resin to have a moderate number of crosslinked structures, thus further improving the water dispersibility of the water-based polyester resin and the stability and film forming ability of the resin dispersion liquid thereof.

A water-based polyester resin according to a thirteenth aspect, which may be implemented in conjunction with any one of the ninth to twelfth aspects, further contains a polyalcohol residue. The polyalcohol residue includes a dihydric alcohol compound residue. The dihydric alcohol compound residue has a branched chain. Proportion of the dihydric alcohol compound residue having the branched chain is equal to or greater than 5% by mass and equal to or less than 50% by mass with respect to the entire polyalcohol residue included in the water-based polyester resin.

The thirteenth aspect allows the resin dispersion liquid of the water-based polyester resin to further improve its stability such as aging stability in solution haze.

A water-based coating composition according to a fourteenth aspect contains a water-based polyester resin. The water-based polyester resin includes either the water-based polyester resin produced by the method according to any one of the first to seventh aspects or the water-based polyester resin according to any one of the eighth to thirteenth aspects.

The fourteenth aspect allows the water-based coating composition to have the following advantageous features. Specifically, the water-based coating composition exhibits not only excellent water dispersibility even in the absence of a surfactant, for example, but also good stability when used as a resin dispersion liquid, while reducing the environmental load. In addition, the water-based coating composition includes a terephthalic acid residue derived from a recycled polyester and still has as good resin properties (such as adhesion and transparency) as in a situation where terephthalic acid or a terephthalic acid derivative not derived from a recycled polyester is used. Furthermore, a resin dispersion liquid of the water-based coating composition not only exhibits good water dispersibility for a long term but also has further improved stability such as aging stability in solution haze.

1. A method for producing a water-based polyester resin using a recycled polyester, the method comprising:
a first step including causing an ester formation reaction and a depolymerization reaction using the recycled polyester, a polycarboxylic acid component including a polycarboxylic acid residue and excluding terephthalic acid, and a polyalcohol component; and
a second step including causing a polycondensation reaction by reducing pressure, wherein
the polycarboxylic acid component includes; at least one metal-sulfonate-group-containing polycarboxylic acid compound selected from the group consisting of polycarboxylic acids, each having a metal sulfonate group and including a metal-sulfonate-group-containing polycarboxylic acid residue, and esters and anhydrides thereof; and at least one additional polycarboxylic acid compound selected from the group consisting of polycarboxylic acids other than the terephthalic acid and the metal-sulfonate-group-containing polycarboxylic acid compound and esters and anhydrides thereof,
the first step includes using: the recycled polyester to such an amount that makes proportion of the terephthalic acid residue with respect to a total of the terephthalic acid residue included in the recycled polyester and the polycarboxylic acid residue included in the polycarboxylic acid component equal to or greater than 20% by mass and equal to or less than 72% by mass; and the metal-sulfonate-group-containing polycarboxylic acid compound to such an amount that makes proportion of the metal-sulfonate-group-containing polycarboxylic acid residue with respect to a total of the terephthalic acid residue included in the recycled polyester and the polycarboxylic acid residue included in the polycarboxylic acid component equal to or greater than 5% by mass and equal to or less than 32% by mass, and
the water-based polyester resin thus produced has an acid value equal to or less than 10 mgKOH/g.

2. The method of claim 1, wherein
the first step includes causing the ester formation reaction and the depolymerization reaction after having compounded the recycled polyester, the polycarboxylic acid component, and the polyalcohol component with each other.

3. The method of claim 1, wherein
the first step includes:
causing the ester formation reaction after having compounded the polycarboxylic acid component and the polyalcohol component with each other; and
causing the depolymerization reaction after having added the recycled polyester thereto.

4. The method of claim 1, wherein
the first step includes further using the additional polycarboxylic acid compound to such an amount that makes proportion of an additional polycarboxylic acid residue with respect to the total of the terephthalic acid residue included in the recycled polyester and the polycarboxylic acid residue included in the polycarboxylic acid component equal to or greater than 5% by mass and equal to or less than 50% by mass.

5. The method of claim 1, wherein
the polycarboxylic acid component used in the first step contains no trivalent or higher valent polycarboxylic acid compounds.

6. The method of claim 1, wherein
the polyalcohol component used in the first step either contains no trihydric or higher hydric polyalcohol compound or contains a trihydric or higher hydric polyalcohol compound, and
proportion of the trihydric or higher hydric polyalcohol compound is equal to or less than 5% by mass with respect to the entire polyalcohol component used.

7. The method of claim 1, wherein
the polyalcohol component used in the first step includes a dihydric alcohol compound,
the dihydric alcohol compound has a branched chain, and
proportion of the dihydric alcohol compound having the branched chain is equal to or greater than 5% by mass and equal to or less than 50% by mass with respect to the entire polyalcohol component used.

8. A water-based polyester resin produced by the method of claim 1.

9. A water-based polyester resin containing; a terephthalic acid residue derived from a recycled polyester; and a polycarboxylic acid residue other than the terephthalic acid residue,
the polycarboxylic acid residue includes; a metal-sulfonate-group-containing polycarboxylic acid residue; and an additional polycarboxylic acid residue other than the terephthalic acid residue and the metal-sulfonate-group-containing polycarboxylic acid residue,
proportion of the terephthalic acid residue with respect to the entire polycarboxylic acid residue included in the water-based polyester resin is equal to or greater than 20% by mass and equal to or less than 72% by mass, and proportion of the metal-sulfonate-group-containing polycarboxylic acid residue with respect to the entire polycarboxylic acid residue included in the water-based polyester resin is equal to or greater than 5% by mass and equal to or less than 32% by mass, and
the water-based polyester resin has an acid value equal to or less than 10 mgKOH/g.

10. The water-based polyester resin of claim 9, wherein
proportion of the additional polycarboxylic acid residue with respect to the entire polycarboxylic acid residue included in the water-based polyester resin is equal to or greater than 5% by mass and equal to or less than 50% by mass.

11. The water-based polyester resin of claim 9, wherein
the polycarboxylic acid residue includes no trivalent or higher valent polycarboxylic acid compound residues.

12. The water-based polyester resin of claim 9, further containing a polyalcohol residue, wherein
the polyalcohol residue either contains no trihydric or higher hydric polyalcohol compound residue or contains a trihydric or higher hydric polyalcohol compound residue, and
proportion of the trihydric or higher hydric polyalcohol compound residue is equal to or less than 5% by mass with respect to the entire polyalcohol residue included in the water-based polyester resin.

13. The water-based polyester resin of claim 9, further containing a polyalcohol residue, wherein
the polyalcohol residue includes a dihydric alcohol compound residue,
the dihydric alcohol compound residue has a branched chain, and
proportion of the dihydric alcohol compound residue having the branched chain is equal to or greater than 5% by mass and equal to or less than 50% by mass with respect to the entire polyalcohol residue included in the water-based polyester resin.

14. A water-based coating composition containing a water-based polyester resin,
the water-based polyester resin including either the water-based polyester resin produced by the method of claim 1.

15. A water-based coating composition containing a water-based polyester resin, the water-based polyester resin including the water-based polyester resin of claim 8.

16. A water-based coating compositing containing a water-based polyester resin,
the water-based polyester resin including the water-based polyester resin of claim 9.
